(19) United States
(12) Patent Application Publication
(10) Pub. No.: US 2012/0003199 A1
(43) Pub. Date: Jan. 5, 2012

(54) USE OF SYNTHETIC AND BIOLOGICAL FUNGICIDES IN COMBINATION FOR CONTROLLING HARMFUL FUNGI

(75) Inventors: Maria Scherer, Landau (DE); Kristin Klappach, Neustadt (DE); Egon Haden, Ludwigshafen (DE)

(73) Assignee: BASF SE, Ludwigshafen (DE)

(21) Appl. No.: 13/259,541

(22) PCT Filed: Mar. 25, 2010
(86) PCT No.: PCT/EP2010/053867

§ 371 Date: Sep. 23, 2011

(30) Foreign Application Priority Data
Mar. 26, 2009 (EP) 09156360.1
Sep. 9, 2009 (EP) 09169871.2

(51) Int. Cl. A01N 63/00; A01P 3/00

(52) U.S. Cl. 424/93.462

(57) ABSTRACT

The present invention relates to the combined use of synthetic fungicides and biological control agents for controlling harmful fungi. To be more precise, the invention relates to a method for controlling harmful fungi, which comprises at least two treatment blocks, where in at least one treatment block the plants are treated with at least one synthetic fungicide and in at least one treatment block the plants are treated with at least one biological control agent, with the proviso that the last treatment block comprises subjecting the plants to at least one treatment with at least one biological control agent.

The present invention relates to the combined use of synthetic fungicides and biological control agents for controlling harmful fungi. To be more precise, the invention relates to a method for controlling harmful fungi, which comprises at least two treatment blocks, where in at least one treatment block the plants are treated with at least one synthetic fungicide and in at least one treatment block the plants are treated with at least one biological control agent, with the proviso that the last treatment block comprises subjecting the plants to at least one treatment with at least one biological control agent.

Synthetic fungicides are often non-specific and therefore can act on organisms other than the target fungus, including other naturally occurring beneficial organisms. Because of their chemical nature, they may also be toxic and non-biodegradable. Consumers world-wide are increasingly conscious of the potential environmental and health problems associated with the residues of chemicals, particularly in food products. This has resulted in growing consumer pressure to reduce the use or at least the quantity of chemical (i.e. synthetic) pesticides. Thus, there is a need to manage food chain requirements whilst still allowing effective pest control.

A further problem arising with the use of synthetic fungicides is that the repeated and exclusive application of a fungicide often leads to selection of resistant fungi. Normally, such fungal strains are also cross-resistant against other active ingredients having the same mode of action. An effective control of the pathogens with said active compounds is then not possible anymore. However, active ingredients having new mechanisms of action are difficult and expensive to develop.

This risk of resistance development in pathogen populations as well as environmental and human health concerns have fostered interest in identifying alternatives to synthetic fungicides for managing plant diseases. The use of biological control agents (BCAs) is one such alternative. However, the effectiveness of most BCAs is not at the same high level as for conventional fungicides, especially in case of severe infection pressure.

Thus, there is an ongoing need for new methods and combinations for plant disease control.

It was therefore an object of the present invention to provide a method for controlling harmful fungi which solves the problems of reducing the dosage rate of synthetic fungicides and thus the amount of residues in the crop, which reduces the risk of resistance formation and nevertheless provides sufficient disease control.

Surprisingly, these objects are achieved by a specific combination of synthetic fungicides and BCAs.

The present invention relates to a method for controlling harmful fungi, which method comprises subjecting plants to be protected against fungal attack to two or more sequential treatment blocks, preferably 2, 3 or 4 sequential treatment blocks, where at least one treatment block comprises subjecting the plants to at least one treatment with at least one synthetic fungicide and at least one treatment block comprises subjecting the plants to at least one treatment with at least one biological control agent, with the proviso that the last treatment block comprises subjecting the plants to at least one treatment with at least one biological control agent (and no synthetic fungicide).

“Synthetic fungicide” refers to fungicides which do not originate from a biological source, but are produced by methods of synthetic chemistry. These are also termed “conventional fungicides” or “chemical fungicides”.

Biological control is defined as the reduction of pest population by natural enemies and typically involves an active human role. The biological control of plant diseases is most often based on an antagonistic action of the BCA. There are several mechanisms by which fungicidal biocontrol is thought to work, including the production of antifungal antibiotics, competition for nutrients and rhizosphere colonization.

“Treatment block” refers to a treatment step which comprises one or more applications of either the at least one synthetic fungicide or the at least one biological control agent. The different treatment blocks are distinguished by the type of active compounds used (one treatment block comprises the application of either the at least one synthetic fungicide or the at least one BCA) and by time (i.e. the different treatment blocks do not overlap). However, if there are more than two treatment blocks, one treatment block may comprise the combined treatment with at least one synthetic fungicide and at least one BCA, e.g. by applying a mixture of at least one synthetic fungicide and at least one BCA, with the proviso that the last treatment block comprises subjecting the plants to at least one treatment with at least one biological control agent (and no synthetic fungicide). It is however preferred that no treatment block comprises the combined treatment with at least one synthetic fungicide and at least one BCA; in other words it is preferred that each treatment block comprises the application of either the at least one synthetic fungicide or the at least one BCA.

The “last” treatment block is that treatment block which is the last fungicidal treatment block in a season, e.g. before, during or latest after harvest (treatment of the crop) or before the plant's death (in case of annual plants).

The above and the following observations made with regard to preferred features of the invention apply by themselves, but also in combination with other preferred features.

Preferably, the method of the invention comprises two treatment blocks. Thus, the invention preferably relates to a method for controlling harmful fungi, which method comprises subjecting plants to be protected against fungal attack to two sequential treatment blocks, where the first treatment block comprises subjecting the plants to at least one treatment with at least one synthetic fungicide and the second, subsequent treatment block comprises subjecting the plants to at least one treatment with at least one biological control agent.

In a treatment block which comprises subjecting the plants to at least one treatment with at least one synthetic fungicide, no BCA is applied. In a treatment block which comprises subjecting the plants to at least one treatment with at least one BCA, no synthetic fungicide is applied.

In the method of the invention, a treatment block is carried out only after the preceding treatment block has been finished, i.e. the second treatment block is carried out only after the first treatment block has been finished, the third treatment block, if existent, is carried out only after the second treatment block has been finished, etc.

Preferably, the respective treatment blocks are carried out during different growth stages of the plants. In other words, the time interval between the subsequent treatment blocks is preferably such that the plants are in different growth stages when being subjected to the respective treatment blocks, i.e. the first, the second, etc. treatment blocks are carried out during non-overlapping growth stages of the plants, the first treatment block of course being carried out at earlier growth stages than the second, etc. In case of the preferred embodiment of the invention in which the method comprises two treatment blocks, preferably the time interval between the first and the second treatment block is such that the plants are in different growth stages when being subjected to the first and the second treatment blocks, respectively, i.e. the first and the second treatment blocks are preferably carried out during non-overlapping growth stages of the plants, the first treatment block of course being carried out at earlier growth stages.

“Growth stage”, as used in the terms of the present invention, refers to growth stages according to the BBCH extended scale (BBCH Makrostadien; Biologische Bundesanstalt für Land- and Forstwirtschaft [BBCH Macrostages; German Federal Biological Research Center for Agriculture and Forestry]; see www.bba.de/veroeff/bbch/bbcheng.pdf).

Preferably, the first treatment block ends latest when the plants have reached growth stage 81 and the last treatment block begins earliest when the plants are in growth stage 41. As already pointed out, a subsequent block is always and mandatorily carried out after completion of the preceding block; which means for example that if the first treatment block has finished when the plant is in growth stage 81, the second treatment block is carried out only after the completion of the first block, preferably earliest in growth stage 82. The most suitable point of time for the treatment depends, inter alia, from the plant to be treated.

In case of the preferred embodiment of the invention in which the method comprises two treatment blocks, preferably the first treatment block ends latest when the plants have reached growth stage 81 and the second treatment block begins earliest when the plants are in growth stage 41. As already pointed out, the second block is always and mandatorily carried out after completion of the first block; which means for example, that if the first treatment block has finished when the plant is in growth stage 81, the second treatment block is carried out only after the completion of the first block, preferably earliest in growth stage 82. The most suitable point of time for the treatment depends, inter alia, from the plant to be treated.

More preferably, the first treatment block ends latest when the plants have reached growth stage 79 and the last treatment block, which is preferably the second treatment block, begins earliest when the plants are in growth stage 41. Even more preferably, the first treatment block is carried out when the plants are in the growth stage 01 to 79, preferably 10 to 79 and the last treatment block, which is preferably the second treatment block, is carried out when the plants are in the growth stage 41 to 92 or even after harvest, i.e. 41 to 99. The most suitable point of time for the treatment depends, inter alia, from the plant to be treated. More detailed information is given below with respect to specific plants.

In the following, specific plants and the respectively preferred time interval for the preferred two treatment blocks are compiled by way of example:

| | 1^{st} treatment block (syn- | 2^{nd} treatment block |
|---|---|---|
| Plant | thetic fungicide) [GS*] | (BCA) [GS*] |
| grape | finished latest in GS 81, | starting earliest in GS 65, |
| | preferably latest in GS | e.g. 65 through harvest |
| | 75; preferably 19-75 | period (89-92) |
| potatoes, vegetables | finished latest in GS 69; | starting earliest in GS 69, |
| with long vegetation | preferably 12-69 | e.g. 69 through harvest |
| period¹ | | period (89-92) |
| pomefruit, stonefruit, | finished latest in GS 69; | starting earliest in GS 69, |
| tree nuts | preferably 01-69 | e.g. 69 through harvest |
| | | period (89-92) |
| strawberry | finished latest in GS 69; | starting earliest in GS 71 |
| | preferably 55-69 | and continuing during |
| | | harvest period |

*GS = growth stage
¹for example tomatoes, cucumbers, peppers

In a specific embodiment, all treatment blocks which comprise the treatment with at least one synthetic fungicide end latest at the end of the vegetative period of the respective plant. In other words, in this specific embodiment no synthetic fungicide is used for treating the plants after the end of the vegetative period. In this specific embodiment the treatment step with the at least one BCA is carried out after the vegetative period in the pre-harvest period.

In the treatment block in which the at least one synthetic fungicide is used, this is applied at least once, for example 1, 2, 3, 4, 5, 6, 7 or 8 times, preferably 1, 2, 3, 4 or 5 times. The application frequency depends, inter alia, on the pathogen pressure and/or on climatic conditions. For instance, weather conditions which promote fungal attack and proliferation, such as extreme wetness, might require more applications of the at least one synthetic fungicide than dry and hot weather. If there is more than one application of the synthetic fungicides, the time interval between the single applications depends, inter alia, on the pest pressure, the plant to be treated, weather conditions and can be determined by the skilled person. In general, the application frequency as well as the application rates will correspond to what is customary for the respective plant and the respective fungicide under the given conditions, with the exception that after a specific growth stage the treatment with the synthetic fungicide is replaced by a treatment with a BCA. If there is more than one application of the at least one synthetic fungicide, these may be carried out during different growth stages.

In the method of the invention, depending on the type of synthetic fungicide used, the single application rates of the at least one fungicide are from 0.0001 to 7 kg per ha, preferably from 0.005 to 5 kg per ha, more preferably from 0.05 to 2 kg per ha.

In the treatment block in which the at least one BCA is used, this is applied at least once, for example 1, 2, 3, 4, 5, 6, 7 or 8 times, preferably 1, 2, 3, 4, 5 or 6 times, more preferably 1, 2, 3 or 4 times, even more preferably 2, 3 or 4 times and in particular 2 or 3 times. Like in the case of the application of synthetic fungicides, the application frequency depends, inter alia, on the pathogen pressure and/or on climatic conditions. For instance, weather conditions which promote fungal attack and proliferation, such as extreme wetness, might require more applications of the BCA than dry and hot weather. If there is more than one application of the BCA, the time interval between the single applications depends, inter alia, on the pest pressure, the plant to be treated, weather conditions etc., and can be determined by the skilled person. In general, the application frequency as well as the application rates will correspond to what is customary for the respective plant and the respective BCA under the given conditions, with the exception that the treatment with the BCA starts only after the plant has reached a specific growth stage and after the treatment with a synthetic fungicide has been completed. If there is more than one application of the BCA, these may be carried out during different growth stages.

The biological control agent is preferably selected from non-pathogenic, preferably saprophytic, bacteria, metabolites produced therefrom; non-pathogenic, preferably saprophytic, fungi, metabolites produced therefrom; resin acids and plant extracts, especially of Reynoutria sachalinensis. Of course, “non-pathogenic” bacteria and fungi are to be understood as non-pathogenic for the plants to be treated.

Examples of suitable non-pathogenic bacteria are the genera Bacillus, Pseudomonades and Actinomycetes (Streptomyces spp.).

Suitable species of the genus Bacillus are listed below. Suitable species of the genus Pseudomonades (Pseudomonas spp.) are for example P. fluorescens and P. putida.

Suitable species of the genus Actinomycetes (Streptomyces spp.) are for example S. griseus, S. ochraceisleroticus, S. graminofaciens, S. corchousii, S. spiroverticillatus, S. griseovirdis and S. hygroscopicus.

Among the genera Bacillus, Pseudomonades and Actinomycetes (Streptomyces spp.), preference is given to the genus Bacillus, to be more precise Bacillus spp. and in particular Bacillus subtilis, Bacillus cereus, Bacillus mycoides, Bacillus pumilus and Bacillus thuringensis.

More preference is given to Bacillus subtilis. This in turn comprises the species B. subtilis, B. lichenifomis and B. amyloliquefaciens, of which B. subtilis is preferred. It has to be noted that some strains which were originally considered to belong to B. subtilis (strains FZB24 and FZB42) have now been identified to belong to B. amyloliquefaciens. For the sake of simplification, in the context of the present invention they are nevertheless considered as belonging to B. subtilis.

Suitable B. subtilis strains are for example FZB13, FZB14, FZB24, FZB37, FZB38, FZB40, FZB42, FZB44, FZB45, FZB47 from FZB Biotechnik GmbH, Berlin, Germany, Cot1, CL27 and QST713 from AGRAQUEST, USA.

Among these, preference is given strain QST713, which is available as the commercial product Serenade® from AGRAQUEST, USA.

Examples of suitable non-pathogenic fungi are Trichoderma spp., Sporidesmium sclerotiorum and Zygomycetes. One example of a commercially available fungus is BOTRY-Zen from BOTRY-Zen Ltd., New Zealand. This product contains a non-pathogenic saprophytic fungus that acts as a biological control agent by competing for the same biological niche as Botrytis cinerea and Sclerotinia sclerotiorum.

Suitable resin acids are for example resin acids extracted from hops. They are commercially available, e.g. as BetaStab® and IsoStab® from BetaTec, USA.

Plant extracts of Reynoutria sachalinensis are for example available in form of the commercial product Milsana® from Dr. Schaette A G, Bad Waldsee, Germany.

The above-mentioned metabolites produced by the non-pathogenic bacteria include antibiotics, enzymes, siderophores and growth promoting agents, for example zwittermicin-A, kanosamine, polyoxine, enzymes, such as α-amylase, chitinases, and pektinases, phytohormones and precursors thereof, such as auxines, gibberellin-like substances, cytokinin-like compounds, lipopeptides such as iturins, plipastatins or surfactins, e.g. agrastatin A, bacillomycin D, bacilysin, difficidin, macrolactin, fengycin, bacilysin and bacilaene. Preferred metabolites are the above-listed lipopeptides, in particular produced by B. subtilis and specifically B. subtilis strain QST713.

The biological control agent is particularly preferably selected from non-pathogenic bacteria, from metabolites produced therefrom and from plant extracts of Reynoutria sachalinensis. Especially, the biological control agent is particularly preferably selected from non-pathogenic bacteria and metabolites produced therefrom. As to suitable and preferred bacteria, reference is made to the above remarks.

The synthetic fungicide is preferably selected from
A) azoles, selected from the group consisting of
   azaconazole, bitertanol, bromuconazole, cyproconazole, difenoconazole, diniconazole, diniconazole-M, epoxiconazole, fenbuconazole, fluquinconazole, flusilazole, flutriafol, hexaconazole, imibenconazole, ipconazole, metconazole, myclobutanil, oxpoconazole, paclobutrazole, penconazole, propiconazole, prothioconazole, simeconazole, tebuconazole, tetraconazole, triadimefon, triadimenol, triticonazole, uniconazole, 1-(4-chloro-phenyl)-2-([1,2,4]triazol-1-yl)cycloheptanol, cyazofamid, imazalil, pefurazoate, prochloraz, triflumizol, benomyl, carbendazim, fuberidazole, thiabendazole, ethaboxam, etridiazole, hymexazole and 2-(4-chloro-phenyl)-N-[4-(3,4-dimethoxy-phenyl)-isoxazol-5-yl]-2-prop-2-ynyloxy-acetamide;
B) strobilurins, selected from the group consisting of
   azoxystrobin, dimoxystrobin, enestroburin, fluoxastrobin, kresoxim-methyl, metominostrobin, orysastrobin, picoxystrobin, pyraclostrobin, pyribencarb, trifloxystrobin, 2-(2-(6-(3-chloro-2-methyl-phenoxy)-5-fluoro-pyrimidin-4-yloxy)-phenyl)-2-methoxyimino-N-methyl-acetamide, 3-methoxy-2-(2-(N-(4-methoxy-phenyl)cyclopropane-carboximidoylsulfanylmethyl)-phenyl)-acrylic acid methyl ester, methyl (2-chloro-5-[1-(3-methylbenzyloxyimino)ethyl]benzyl)carbamate and 2-(2-(3-(2,6-dichlorophenyl)-1-methyl-allylideneaminooxymethyl)-phenyl)-2-methoxyimino-N-methyl-acetamide;
C) carboxamides, selected from the group consisting of
   benalaxyl, benalaxyl-M, benodanil, bixafen, boscalid, carboxin, fenfuram, fenhexamid, flutolanil, furametpyr, isopyrazam, isotianil, kiralaxyl, mepronil, metalaxyl, metalaxyl-M (mefenoxam), ofurace, oxadixyl, oxycarboxin, penthiopyrad, sedaxane, tecloftalam, thifluzamide, tiadinil, 2-amino-4-methylthiazole-5-carboxanilide, 2-chloro-N-(1,1,3-trimethyl-indan-4-yl)-nicotinamide, N-(3′,4′,5′-trifluorobiphenyl-2-yl)-3-difluoromethyl-1-methyl-1H-pyrazole-4-carboxamide, N-(4′-trifluoromethylthiobiphenyl-2-yl)-3-difluoromethyl-1-methyl-1H-pyrazole-4-carboxamide, N-(2-(1,3-dimethyl-butyl)-phenyl)-1,3-dimethyl-5-fluoro-1H-pyrazole-4-carboxamide and N-(2-(1,3,3-trimethyl-butyl)-phenyl)-1,3-dimethyl-5-fluoro-1H-pyrazole-4-carboxamide, dimethomorph, flumorph, pyrimorph, flumetover, fluopicolide, fluopyram, zoxamide, N-(3-Ethyl-3,5,5-trimethylcyclohexyl)-3-formylamino-2-hydroxy-benzamide, carpropamid, dicyclomet, mandiproamid, oxytetracyclin, silthiofarm and N-(6-methoxy-pyridin-3-yl)cyclopropanecarboxylic acid amide;
D) heterocyclic compounds, selected from the group consisting of
   fluazinam, pyrifenox, 3-[5-(4-chloro-phenyl)-2,3-dimethyl-isoxazolidin-3-yl]-pyridine, 3-[5-(4-methyl-phenyl)-2,3-dimethyl-isoxazolidin-3-yl]-pyridine, 2,3,5,6-tetra-chloro-4-methanesulfonyl-pyridine, 3,4,5-trichloropyridine-2,6-di-carbonitrile, N-(1-(5-bromo-3-chloro-pyridin-2-yl)-ethyl)-2,4-dichloronicotinamide, N-[(5-bromo-3-chloro-pyridin-2-yl)-methyl]-2,4-dichloro-nicotinamide, bupirimate, cyprodinil, diflumetorim, fenarimol, ferimzone, mepanipyrim, nitrapyrin, nuarimol, pyrimethanil, triforine, fenpiclonil, fludioxonil, aldimorph, dodemorph, dodemorph-acetate, fenpropimorph, tridemorph, fenpropidin, fluoroimid, iprodione, procymidone, vinclozolin, famoxadone, fenamidone, flutianil, octhilinone, probenazole, 5-amino-2-isopropyl-3-oxo-4-ortho-tolyl-2,3-dihydro-pyrazole-1-carbothioic acid S-allyl ester, acibenzolar-5-methyl, amisulbrom, anilazin, blasticidin-S, captafol, captan, chinomethionat, dazomet, debacarb, diclomezine, difenzoquat, difenzoquat-methylsulfate, fenoxanil, Folpet, oxolinic acid, piperalin, proquinazid, pyroquilon, quinoxyfen, triazoxide, tricyclazole, 2-butoxy-6-iodo-3-propylchromen-4-one, 5-chloro-1-(4,6-dimethoxy-pyrimidin-2-yl)-2-methyl-1H-benzoimidazole, 5-chloro-7-(4-methylpiperidin-1-yl)-6-(2,4,6-trifluorophenyl)-[1,2,4]triazolo[1,5-a]pyrimidine, and 5-ethyl-6-octyl-[1,2,4]triazolo[1,5-a]pyrimidine-7-ylamine (“BAS 650”);
E) carbamates, selected from the group consisting of
   ferbam, mancozeb, maneb, metam, methasulphocarb, metiram, propineb, thiram, zineb, ziram, benthiavalicarb, diethofencarb, iprovalicarb, propamocarb, propamocarb hydrochlorid, valiphenal and N-(1-(1-(4-cyano-phenyl)ethanesulfonyl)-but-2-yl) carbamic acid-(4-fluorophenyl) ester; and
F) other active compounds, selected from the group consisting of
   guanidines: guanidine, dodine, dodine free base, guazatine, guazatine-acetate, iminoctadine, iminoctadine-triacetate, iminoctadine-tris(albesilate);
   nitrophenyl derivates: binapacryl, dinobuton, dinocap, nitrthal-isopropyl, tecnazen,
   organometal compounds: fentin salts, such as fentin-acetate, fentin chloride or fentin hydroxide;
   sulfur-containing heterocyclyl compounds: dithianon, isoprothiolane;
   organophosphorus compounds: edifenphos, fosetyl, fosetyl-aluminum, iprobenfos, phosphorous acid and its salts, pyrazophos, tolclofos-methyl;
   organochlorine compounds: chlorothalonil, dichlofluanid, dichlorophen, flusulfamide, hexachlorobenzene, pencycuron, pentachlorphenole and its salts, phthalide, quintozene, thiophanate-methyl, tolylfluanid, N-(4-chloro-2-nitrophenyl)-N-ethyl-4-methyl-benzenesulfonamide;
   inorganic active substances: Bordeaux mixture, copper acetate, copper hydroxide, copper oxychloride, basic copper sulfate, sulfur;
   others: biphenyl, bronopol, cyflufenamid, cymoxanil, diphenylamin, metrafenone, mildiomycin, oxin-copper, prohexadione-calcium, spiroxamine, tolylfluanid, N-(cyclopropylmethoxyimino-(6-difluoro-methoxy-2,3-difluorophenyl)-methyl)-2-phenyl acetamide, N′-(4-(4-chloro-3-trifluoromethylphenoxy)-2,5-dimethyl-phenyl)-N-ethyl-N-methyl formamidine, N′-(4-(4-fluoro-3-trifluoromethyl-phenoxy)-2,5-dimethyl-phenyl)-N-ethyl-N-methyl formamidine, N′-(2-methyl-5-trifluoromethyl-4-(3-trimethylsilanyl-propoxy)-phenyl)-N-ethyl-N-methyl formamidine, N′-(5-difluoromethyl-2-methyl-4-(3-trimethylsilanylpropoxy)-phenyl)-N-ethyl-N-methyl formamidine, 2-{1-[2-(5-methyl-3-trifluoromethyl-pyrazole-1-yl)-acetyl]-piperidin-4-yl}-thiazole-4-carboxylic acid methyl-(1,2,3,4-tetrahydro-naphthalen-1-yl)-amide, 2-{1-[2-(5-methyl-3-trifluoromethyl-pyrazole-1-yl)-acetyl]-piperidin-4-yl}-thiazole-4-carboxylic acid methyl-(R)-1,2,3,4-tetrahydro-naphthalen-1-yl-amide, acetic acid 6-tert.-butyl-8-fluoro-2,3-dimethyl-quinolin-4-yl ester and methoxy-acetic acid 6-tert-butyl-8-fluoro-2,3-dimethyl-quinolin-4-yl ester;
      and mixtures thereof.

Specifically, the synthetic fungicide is selected from boscalid, metrafenone, dithianon, 7-amino-6-octyl-5-ethyltriazolopyrimidine, pyraclostrobin, kresoxim-methyl, pyrimethanil, metiram, difenoconazole, cyprodinil, fludioxonil and mixtures thereof. In a very specific embodiment, the synthetic fungicide is boscalid.

Especially, in the method of the invention
the biological control agent is Bacillus subtilis strain QST 713 and the synthetic fungicide is boscalid; or
the biological control agent is Bacillus subtilis strain QST 713 and the synthetic fungicide is metrafenone; or
the biological control agent is Bacillus subtilis strain QST 713 and the synthetic fungicide is dithianon; or
the biological control agent is Bacillus subtilis strain QST 713 and the synthetic fungicide is 5-ethyl-6-octyl-[1,2,4]triazolo[1,5-a]pyrimidine-7-ylamine; or
the biological control agent is Bacillus subtilis strain QST 713 and the synthetic fungicide is pyraclostrobin; or
the biological control agent is Bacillus subtilis strain QST 713 and the synthetic fungicide is fludioxonil; or
the biological control agent is Bacillus subtilis strain QST 713 and the synthetic fungicide is cyprodinil; or
the biological control agent is Bacillus subtilis strain QST 713 and the synthetic fungicide is difenoconazole; or
the biological control agent is Bacillus subtilis strain QST 713 and the synthetic fungicide is a combination of pyraclostrobin and boscalid, specifically a mixture of pyraclostrobin and boscalid; or
the biological control agent is Bacillus subtilis strain QST 713 and the synthetic fungicide is metiram; or
the biological control agent is Bacillus subtilis strain QST 713 and the synthetic fungicide is pyrimethanil; or
the biological control agent is Bacillus subtilis strain QST 713 and the synthetic fungicide is kresoxim-methyl; or
the biological control agent is Bacillus subtilis strain QST 713 and the synthetic fungicide is a combination of pyrimethanil and dithianon, specifically a mixture of pyrimethanil and dithianon; or
the biological control agent is Bacillus subtilis strain QST 713 and the synthetic fungicide is a combination of pyraclostrobin and dithianon, specifically a mixture of pyraclostrobin and dithianon; or
the biological control agent is Bacillus subtilis strain QST 713 and the synthetic fungicide is a combination of boscalid and kresoxim-methyl, specifically a mixture of boscalid and kresoxim-methyl; or
the biological control agent is Bacillus subtilis strain QST 713 and the synthetic fungicide is a combination of pyraclostrobin and metiram, specifically a mixture of pyraclostrobin and metiram; or
the biological control agent is Bacillus subtilis strain QST 713 and the synthetic fungicide is a combination of dithianon, pyrimethanil and pyraclostrobin, specifically a combination of dithianon, a mixture of dithianon and pyrimethanil and a mixture of dithianon and pyraclostrobin; or
the biological control agent is Bacillus subtilis strain QST 713 and the synthetic fungicide is a combination of metrafenone, boscalid and kresoxim-methyl, specifically a combination of metrafenone and a mixture of boscalid and kresoxim-methyl; or
the biological control agent is Bacillus subtilis strain QST 713 and the synthetic fungicide is a combination of metrafenone, pyraclostrobin, metiram and boscalid, specifically a combination of metrafenone, a mixture of pyraclostrobin and metiram and boscalid; or
the biological control agent is Bacillus subtilis strain QST 713 and the synthetic fungicide is a combination of boscalid, fludioxonil and cyprodinil, specifically a combination of boscalid and a mixture of fludioxonil and cyprodinil; or
the biological control agent is Bacillus subtilis strain QST 713 and the synthetic fungicide is a combination of difenoconazole, boscalid and pyraclostrobin, specifically a combination of difenoconazole and a mixture of boscalid and pyraclostrobin; or
the biological control agent is an extract of Reynoutria sachalinensis and the synthetic fungicide is metrafenon.

If the synthetic fungicide in the above list of the especially preferred embodiment of the method of the invention is a combination of several synthetic fungicides, this means that the treatment block comprises the subsequent application of the different fungicides/fungicidal mixtures listed. However, the order given in the list is not mandatory and the treatment step may comprise more than one application of the fungicides/fungicidal mixtures listed.

For the use according to the present invention, the synthetic fungicide can be converted into the customary types of agrochemical formulations, for example solutions, emulsions, suspensions, dusts, powders, pastes and granules. The composition type depends on the particular intended purpose; in each case, it should ensure a fine and uniform distribution of the active compound.

Examples for composition types are suspensions (SC, OD, FS), emulsifiable concentrates (EC), emulsions (EW, EO, ES), pastes, pastilles, wettable powders or dusts (WP, SP, SS, WS, DP, DS) or granules (GR, FG, GG, MG), which can be water-soluble or wettable, as well as gel formulations for the treatment of plant propagation materials such as seeds (GF).

Usually the composition types (e.g. SC, OD, FS, EC, WG, SG, WP, SP, SS, WS, GF) are employed diluted. Composition types such as DP, DS, GR, FG, GG and MG are usually used undiluted.

The compositions are prepared in a known manner (cf. U.S. Pat. No. 3,060,084, EP-A 707 445 (for liquid concentrates), Browning: “Agglomeration”, Chemical Engineering, Dec. 4, 1967, 147-48, Perry's Chemical Engineer's Handbook, 4th Ed., McGraw-Hill, New York, 1963, pp. 8-57 et seq., WO 91/13546, U.S. Pat. No. 4,172,714, U.S. Pat. No. 4,144,050, U.S. Pat. No. 3,920,442, U.S. Pat. No. 5,180,587, U.S. Pat. No. 5,232,701, U.S. Pat. No. 5,208,030, GB 2,095,558, U.S. Pat. No. 3,299,566, Klingman: Weed Control as a Science (J. Wiley & Sons, New York, 1961), Hance et al.: Weed Control Handbook (8th Ed., Blackwell Scientific, Oxford, 1989) and Mollet, H. and Grubemann, A.: Formulation technology (Wiley VCH Verlag, Weinheim, 2001), for example by extending the active compounds with solvents and/or carriers, if desired using emulsifiers and dispersants.

The agrochemical compositions may also comprise auxiliaries which are customary in agrochemical compositions. The auxiliaries used depend on the particular application form and active substance, respectively.

Examples for suitable auxiliaries are solvents, solid carriers, dispersants or emulsifiers (such as further solubilizers, protective colloids, surfactants, spreaders and adhesion agents), organic and anorganic thickeners, bactericides, anti-freezing agents, anti-foaming agents, if appropriate colorants and tackifiers or binders (e.g. for seed treatment formulations).

Suitable solvents are water, organic solvents such as mineral oil fractions of medium to high boiling point, such as kerosene or diesel oil, furthermore coal tar oils and oils of vegetable or animal origin, aliphatic, cyclic and aromatic hydrocarbons, e.g. toluene, xylene, paraffin, tetrahydronaphthalene, alkylated naphthalenes or their derivatives, alcohols such as methanol, ethanol, propanol, butanol and cyclohexanol, glycols, ketones such as cyclohexanone and gamma-butyrolactone, fatty acid dimethylamides, fatty acids and fatty acid esters and strongly polar solvents, e.g. amines such as N-methylpyrrolidone.

Solid carriers are mineral earths such as silicates, silica gels, talc, kaolins, limestone, lime, chalk, bole, loess, clays, dolomite, diatomaceous earth, calcium sulfate, magnesium sulfate, magnesium oxide, ground synthetic materials, fertilizers, such as, e.g., ammonium sulfate, ammonium phosphate, ammonium nitrate, ureas, and products of vegetable origin, such as cereal meal, tree bark meal, wood meal and nutshell meal, cellulose powders and other solid carriers.

Suitable surfactants (adjuvants, wetters, tackifiers, dispersants or emulsifiers) are alkali metal, alkaline earth metal and ammonium salts of aromatic sulfonic acids, such as ligninsoulfonic acid (Borresperse® types, Borregard, Norway) phenolsulfonic acid, naphthalenesulfonic acid (Morwet® types, Akzo Nobel, U.S.A.), dibutylnaphthalenesulfonic acid (Nekal® types, BASF, Germany), and fatty acids, alkylsulfonates, alkylarylsulfonates, alkyl sulfates, laurylether sulfates, fatty alcohol sulfates, and sulfated hexa-, hepta- and octadecanolates, sulfated fatty alcohol glycol ethers, furthermore condensates of naphthalene or of naphthalenesulfonic acid with phenol and formaldehyde, polyoxy-ethylene octylphenyl ether, ethoxylated isooctylphenol, octylphenol, nonylphenol, alkylphenyl polyglycol ethers, tributylphenyl polyglycol ether, tristearylphenyl polyglycol ether, alkylaryl polyether alcohols, alcohol and fatty alcohol/ethylene oxide condensates, ethoxylated castor oil, polyoxyethylene alkyl ethers, ethoxylated polyoxypropylene, lauryl alcohol polyglycol ether acetal, sorbitol esters, lignin-sulfite waste liquors and proteins, denatured proteins, polysaccharides (e.g. methylcellulose), hydrophobically modified starches, polyvinyl alcohols (Mowiol® types, Clariant, Switzerland), polycarboxylates (Sokolan® types, BASF, Germany), polyalkoxylates, polyvinylamines (Lupasol® types, BASF, Germany), polyvinylpyrrolidone and the copolymers thereof.

Suitable spreaders (compounds which reduce the surface tension of aqueous compositions and improve the penetration through cuticular layers, thus increasing the uptake of crop protection agents by plants) are for example trisiloxane surfactants such as polyether/polymethylsiloxan copolymers (Break Thru® products from Evonik Industries, Germany).

Examples for thickeners (i.e. compounds that impart a modified flowability to compositions, i.e. high viscosity under static conditions and low viscosity during agitation) are polysaccharides and organic and anorganic clays such as Xanthan gum (Kelzan®, CP Kelco, U.S.A.), Rhodopol® 23 (Rhodia, France), Veegum® (R.T. Vanderbilt, U.S.A.) or Attaclay® (Engelhard Corp., NJ, USA).

Bactericides may be added for preservation and stabilization of the composition. Examples for suitable bactericides are those based on dichlorophene and benzylalcohol hemi formal (Proxel® from ICI or Acticide® RS from Thor Chemie and Kathon® MK from Rohm & Haas) and isothiazolinone derivatives such as alkylisothiazolinones and benzisothiazolinones (Acticide® MBS from Thor Chemie).

Examples for suitable anti-freezing agents are ethylene glycol, propylene glycol, urea and glycerin.

Examples for anti-foaming agents are silicone emulsions (such as e.g. Silikon® SRE, Wacker, Germany or Rhodorsil®, Rhodia, France), long chain alcohols, fatty acids, salts of fatty acids, fluoroorganic compounds and mixtures thereof.

Suitable colorants are pigments of low water solubility and water-soluble dyes. Examples to be mentioned are rhodamin B, C. I. pigment red 112, C. I. solvent red 1, pigment blue 15:4, pigment blue 15:3, pigment blue 15:2, pigment blue 15:1, pigment blue 80, pigment yellow 1, pigment yellow 13, pigment red 112, pigment red 48:2, pigment red 48:1, pigment red 57:1, pigment red 53:1, pigment orange 43, pigment orange 34, pigment orange 5, pigment green 36, pigment green 7, pigment white 6, pigment brown 25, basic violet 10, basic violet 49, acid red 51, acid red 52, acid red 14, acid blue 9, acid yellow 23, basic red 10, basic red 108.

Examples for tackifiers or binders are polyvinylpyrrolidons, polyvinylacetates, polyvinyl alcohols and cellulose ethers (Tylose®, Shin-Etsu, Japan).

Powders, materials for spreading and dusts can be prepared by mixing or concomitantly grinding the active compounds and, if appropriate, further active substances, with at least one solid carrier.

Granules, e.g. coated granules, impregnated granules and homogeneous granules, can be prepared by binding the active substances to solid carriers. Examples of solid carriers are mineral earths such as silica gels, silicates, talc, kaolin, attaclay, limestone, lime, chalk, bole, loess, clay, dolomite, diatomaceous earth, calcium sulfate, magnesium sulfate, magnesium oxide, ground synthetic materials, fertilizers, such as, e.g., ammonium sulfate, ammonium phosphate, ammonium nitrate, ureas, and products of vegetable origin, such as cereal meal, tree bark meal, wood meal and nutshell meal, cellulose powders and other solid carriers.

The following are examples of formulations:

1. Products for Dilution with Water

For seed treatment purposes, such products may be applied to the seed diluted or undiluted.

### A Water-soluble Concentrates (SL, LS)

10 parts by weight of the active compounds are dissolved in 90 parts by weight of water or a water-soluble solvent. As an alternative, wetting agents or other auxiliaries are added. The active compound dissolves upon dilution with water. A formulation having an active compound content of 10% by weight is obtained in this manner.

### B Dispersible Concentrates (DC)

20 parts by weight of the active compounds are dissolved in 70 parts by weight of cyclohexanone with addition of 10 parts by weight of a dispersant, for example polyvinylpyrrolidone. Dilution with water gives a dispersion. The active compound content is 20% by weight.

### C Emulsifiable Concentrates (EC)

15 parts by weight of the active compounds are dissolved in 75 parts by weight of xylene with addition of calcium dodecylbenzenesulfonate and castor oil ethoxylate (in each case 5 parts by weight). Dilution with water gives an emulsion. The formulation has an active compound content of 15% by weight.

### D Emulsions (EW, EO, ES)

25 parts by weight of the active compounds are dissolved in 35 parts by weight of xylene with addition of calcium dodecylbenzenesulfonate and castor oil ethoxylate (in each case 5 parts by weight). This mixture is introduced into 30 parts by weight of water by means of an emulsifying machine (e.g. Ultraturrax) and made into a homogeneous emulsion. Dilution with water gives an emulsion. The formulation has an active compound content of 25% by weight.

### E Suspensions (SC, OD, FS)

In an agitated ball mill, 20 parts by weight of the active compounds are comminuted with addition of 10 parts by weight of dispersants and wetting agents and 70 parts by weight of water or an organic solvent to give a fine active compound suspension. Dilution with water gives a stable suspension of the active compound. The active compound content in the formulation is 20% by weight.

### F Water-Dispersible Granules and Water-Soluble Granules (WG, SG)

50 parts by weight of the active compounds are ground finely with addition of 50 parts by weight of dispersants and wetting agents and prepared as water-dispersible or water-soluble granules by means of technical appliances (for example extrusion, spray tower, fluidized bed). Dilution with water gives a stable dispersion or solution of the active compound. The formulation has an active compound content of 50% by weight.

### G Water-Dispersible Powders and Water-Soluble Powders (WP, SP, SS, WS)

75 parts by weight of the active compounds are ground in a rotor-stator mill with addition of 25 parts by weight of dispersants and wetting agents as well as silica gel. Dilution with water gives a stable dispersion or solution of the active compound. The active compound content of the formulation is 75% by weight.

### H Gel (GF)

In an agitated ball mill, 20 parts by weight of the active compounds are comminuted with addition of 10 parts by weight of dispersants, 1 part by weight of gelling agent wetters and 70 parts by weight of water or an organic solvent to give a fine suspension of the active compounds. Dilution with water gives a stable suspension of the active compounds having an active compound content of 20% by weight.

### 2. Products to be Applied Undiluted

### I Dustable Powders (DP, DS)

5 parts by weight of the active compounds are ground finely and mixed intimately with 95 parts by weight of finely divided kaolin. This gives a dustable product having an active compound content of 5% by weight.

### Granules (GR, FG, GG, MG)

0.5 part by weight of the active compounds is ground finely and associated with 99.5 parts by weight of carriers. Current methods are extrusion, spray-drying or the fluidized bed. This gives granules to be applied undiluted having an active compound content of 0.5% by weight.

### K ULV Solutions (UL)

10 parts by weight of the active compounds are dissolved in 90 parts by weight of an organic solvent, for example xylene. This gives a product to be applied undiluted having an active compound content of 10% by weight.

In general, the formulations (agrochemical compositions) comprise from 0.01 to 95% by weight, preferably from 0.1 to 90% by weight and more preferably from 0.5 to 90% by weight, of the active compounds. The active compounds are employed in a purity of from 90% to 100%, preferably 95% to 100% (according to NMR spectrum).

Water-soluble concentrates (LS), flowable concentrates (FS), powders for dry treatment (DS), water-dispersible powders for slurry treatment (WS), water-soluble powders (SS), emulsions (ES) emulsifiable concentrates (EC) and gels (GF) are usually employed for the purposes of treatment of plant propagation materials, particularly seeds. These formulations can be applied to plant propagation materials, particularly seeds, diluted or undiluted. The formulations in question give, after two-to-tenfold dilution, active substance concentrations of from 0.01 to 60% by weight, preferably from 0.1 to 40% by weight, in the ready-to-use preparations. Application can be carried out before or during sowing. Methods for applying or treating with agrochemical compounds and compositions thereof, respectively, on to plant propagation material, especially seeds, are known in the art, and include dressing, coating, pelleting, dusting, soaking and in-furrow application methods of the propagation material. In a preferred embodiment, the active compounds or the compositions thereof, respectively, are applied on to the plant propagation material by a method such that germination is not induced, e.g. by seed dressing, pelleting, coating and dusting.

In a preferred embodiment, a suspension-type (FS) formulation is used for seed treatment. Typically, a FS formulation may comprise 1-800 g/l of active substance, 1-200 g/l surfactant, 0 to 200 g/l antifreezing agent, 0 to 400 g/l of binder, 0 to 200 g/l of a pigment and up to 1 liter of a solvent, preferably water.

The at least one synthetic fungicide can be used as such, in the form of its formulations (agrochemical compositions) or the use forms prepared therefrom, for example in the form of directly sprayable solutions, powders, suspensions, dispersions, emulsions, oil dispersions, pastes, dustable products, materials for spreading, or granules, by means of spraying, atomizing, fogging, dusting, spreading, brushing, immersing or pouring. The application forms depend entirely on the intended purposes; the intention is to ensure in each case the finest possible distribution of the active compounds used according to the invention.

Aqueous application forms can be prepared from emulsion concentrates, pastes or wettable powders (sprayable powders, oil dispersions) by adding water. To prepare emulsions, pastes or oil dispersions, the substances, as such or dissolved in an oil or solvent, can be homogenized in water by means of a wetter, tackifier, dispersant or emulsifier. Alternatively, it is possible to prepare concentrates composed of active substance, wetter, tackifier, dispersant or emulsifier and, if appropriate, solvent or oil, and such concentrates are suitable for dilution with water.

The active compound concentrations in the ready-to-use preparations can be varied within relatively wide ranges. In general, they are from 0.0001 to 10%, preferably from 0.001 to 1%.

The active compounds may also be used successfully in the ultra-low-volume process (ULV), it being possible to apply formulations (compositions) comprising over 95% by weight of active compound, or even to apply the active compounds without additives.

Also the BCAs can be converted into the customary types of agrochemical formulations, for example solutions, emulsions, suspensions, dusts, powders, pastes and granules. Preferably, they are used in the form of aqueous or alcoholic extracts.

The method of the invention is generally carried out by bringing the plant to be treated, parts of plant, the harvested crops, the locus where the plant is growing or is intended to grow and/or its propagules in contact with the active compounds (synthetic fungicide(s) or BCA(s)). To this end, the active components are applied to the plant, parts of plant, the harvested crops, the locus where the plant is growing or is intended to grow and/or its propagules.

The term “propagules” represents all types of plant propagation material from which a complete plant can be grown, such as seeds, grains, fruits, tubers, the rhizome, spores, cuttings, slips, meristem tissue, individual plant cells and any form of plant tissue from which a complete plant can be grown. Preferably, it takes the form of seeds.

“Locus” refers to any type of substrate in which the plant grows or will grow, such as soil (for example in a pot, in borders or in the field) or artificial media. As a rule, it takes the form of the soil.

For treating the propagules, in particular the seed, it is possible in principle to use any customary methods for treating or dressing seed, such as, but not limited to, seed dressing, seed coating, seed dusting, seed soaking, seed film coating, seed multilayer coating, seed encrusting, seed dripping, and seed pelleting. Specifically, the treatment is carried out by mixing the seed with the particular amount desired of seed dressing formulations either as such or after prior dilution with water in an apparatus suitable for this purpose, for example a mixing apparatus for solid or solid/liquid mixing partners, until the composition is distributed uniformly on the seed. If appropriate, this is followed by a drying operation.

Treatment of the propagules is in general only suitable for seasonal, in particular annual plants, i.e. for plants which are completely harvested after one season and which have to be replanted for the next season.

For treating the locus where the plant is growing or intended to grow, especially the soil, the latter may be treated by applying to the soil a suitable amount of the respective active compound either as such or after prior dilution with water.

In case the plants or (overground) parts thereof are to be treated, this is preferably done by spraying the plant or parts thereof, preferably their leaves (foliar application). Here, application can be carried out, for example, by customary spray techniques using spray liquor amounts of from about 100 to 1000 l/ha (for example from 300 to 400 l/ha) using water as carrier. Application of the active compounds by the low-volume and ultra-low-volume method is possible, as is their application in the form of microgranules. Another suitable application method for treating the plants or (overground) parts thereof is fog application.

The latter applies to the treatment of harvested crops, too. Moreover, dusting is also possible.

If the treatment of the invention comprises the treatment of the propagules, this is preferably carried out only during the first treatment block. If the treatment of the invention comprises the treatment of the harvested crops, this is preferably carried out only during the last treatment block.

The treatments in the method according to the invention with the at least one synthetic fungicide and the at least one BCA is preferably carried out in the form of foliar treatment and/or soil treatment and more preferably as foliar treatment of the plants.

The plants to be treated are preferably cultivated plants, especially agricultural or ornamental plants.

Preferably, the plants are selected from grape, pome fruit, stone fruit, citrus fruit, tropical fruit, such as banana, mango and papaya, strawberry, blueberry, almond, cucurbit, pumpkin/squash, cucumber, melon, watermelon, kale, cabbage, Chinese cabbage, lettuce, endive, asparagus, carrot, celeriac, kohlrabi, chicory, radish, swede, scorzonerea, Brussels sprout, cauliflower, broccoli, onion, leek, garlic, shallot, tomato, potato, paprika (pepper), sugar beet, fodder beet, lentil, vegetable pea, fodder pea, bean, alfalfa (lucerne), soybeans, oilseed rape, mustard, sunflower, groundnut (peanut), maize (corn), wheat, triticale, rye, barley, oats, millet/sorghum, rice, cotton, flax, hemp, jute, spinach, sugar cane, tobacco and ornamental plants.

Specifically, the plants are selected from grape, pome fruit, stone fruit, cucurbit, melon, cabbage, tomato, paprika (pepper), sugar beet, bean, cucumber, lettuce and carrot. In a very specific embodiment, the plant to be treated is grape (vine).

The term “cultivated plants” is to be understood as including plants which have been modified by breeding, mutagenesis or genetic engineering including but not limiting to agricultural biotech products on the market or in development (cf. http://www.bio.org/speeches/pubs/er/agri_products.asp). Genetically modified plants are plants whose genetic material has been modified by the use of recombinant DNA techniques in such a way that under natural circumstances they cannot readily be obtained by cross breeding, mutations or natural recombination. Typically, one or more genes have been integrated into the genetic material of a genetically modified plant in order to improve certain properties of the plant. Such genetic modifications also include, but are not limited to, targeted post-transitional modification of protein(s), oligo- or polypeptides e.g. by glycosylation or polymer additions such as prenylated, acetylated or farnesylated moieties or PEG moieties.

Plants that have been modified by breeding, mutagenesis or genetic engineering, e.g. have been rendered tolerant to applications of specific classes of herbicides, such as hydroxyphenylpyruvate dioxygenase (HPPD) inhibitors; acetolactate synthase (ALS) inhibitors, such as sulfonyl ureas (see e.g. U.S. Pat. No. 6,222,100, WO 01/82685, WO 00/26390, WO 97/41218, WO 98/02526, WO 98/02527, WO 04/106529, WO 05/20673, WO 03/14357, WO 03/13225, WO 03/14356, WO 04/16073) or imidazolinones (see e.g. U.S. Pat. No. 6,222,100, WO 01/82685, WO 00/026390, WO 97/41218, WO 98/002526, WO 98/02527, WO 04/106529, WO 05/20673, WO 03/014357, WO 03/13225, WO 03/14356, WO 04/16073); enolpyruvylshikimate-3-phosphate synthase (EPSPS) inhibitors, such as glyphosate (see e.g. WO 92/00377); glutamine synthetase (GS) inhibitors, such as glufosinate (see e.g. EP-A 242 236, EP-A 242 246) or oxynil herbicides (see e.g. U.S. Pat. No. 5,559,024) as a result of conventional methods of breeding or genetic engineering. Several cultivated plants have been rendered tolerant to herbicides by conventional methods of breeding (mutagenesis), e.g. Clearfield® summer rape (Canola, BASF SE, Germany) being tolerant to imidazolinones, e.g. imazamox. Genetic engineering methods have been used to render cultivated plants, such as soybean, cotton, corn, beets and rape, tolerant to herbicides such as glyphosate and glufosinate, some of which are commercially available under the trade names RoundupReady® (glyphosate-tolerant, Monsanto, U.S.A.) and LibertyLink® (glufosinate-tolerant, Bayer CropScience, Germany).

Furthermore, plants are also covered that, by the use of recombinant DNA techniques, are capable to synthesize one or more insecticidal proteins, especially those known from the bacterial genus Bacillus, particularly from Bacillus thuringiensis, such as δ-endotoxins, e.g. CryIA(b), CryIA(c), CryIF, CryIF(a2), CryIIA(b), CryIIIA, CryIIIB(b1) or Cry9c; vegetative insecticidal proteins (VIP), e.g. VIP1, VIP2, VIP3 or VIP3A; insecticidal proteins of bacteria colonizing nematodes, e.g. Photorhabdus spp. or Xenorhabdus spp.; toxins produced by animals, such as scorpion toxins, arachnid toxins, wasp toxins, or other insect-specific neurotoxins; toxins produced by fungi, such Streptomycetes toxins, plant lectins, such as pea or barley lectins; agglutinins; proteinase inhibitors, such as trypsin inhibitors, serine protease inhibitors, patatin, cystatin or papain inhibitors; ribosome-inactivating proteins (RIP), such as ricin, maize-RIP, abrin, luffin, saporin or bryodin; steroid metabolism enzymes, such as 3-hydroxysteroid oxidase, ecdysteroid-IDP-glycosyl-transferase, cholesterol oxidases, ecdysone inhibitors or HMG-CoA-reductase; ion channel blockers, such as blockers of sodium or calcium channels; juvenile hormone esterase; diuretic hormone receptors (helicokinin receptors); stilben synthase, bibenzyl synthase, chitinases or glucanases. In the context of the present invention these insecticidal proteins or toxins are to be understood expressly also as pre-toxins, hybrid proteins, truncated or otherwise modified proteins. Hybrid proteins are characterized by a new combination of protein domains, (see, e.g. WO 02/015701). Further examples of such toxins or genetically modified plants capable of synthesizing such toxins are disclosed, e.g., in EP-A 374 753, WO 93/007278, WO 95/34656, EP-A 427 529, EP-A 451 878, WO 03/18810 and WO 03/52073. The methods for producing such genetically modified plants are generally known to the person skilled in the art and are described, e.g., in the publications mentioned above. These insecticidal proteins contained in the genetically modified plants impart to the plants producing these proteins tolerance to harmful pests from all taxonomic groups of arthropods, especially to beetles (Coeloptera), two-winged insects (Diptera), and moths (Lepidoptera) and to nematodes (Nematoda). Genetically modified plants capable to synthesize one or more insecticidal proteins are, e.g., described in the publications mentioned above, and some of them are commercially available such as YieldGard® (corn cultivars producing the Cry1Ab toxin), YieldGard® Plus (corn cultivars producing Cry1Ab and Cry3Bb1 toxins), Starlink® (corn cultivars producing the Cry9c toxin), Herculex® RW (corn cultivars producing Cry34Ab1, Cry35Ab1 and the enzyme Phosphinothricin-N-Acetyltransferase [PAT]); NuCOTN® 33B (cotton cultivars producing the Cry1Ac toxin), Bollgard® I (cotton cultivars producing the Cry1Ac toxin), Bollgard® II (cotton cultivars producing Cry1Ac and Cry2Ab2 toxins); VIPCOT® (cotton cultivars producing a VIP-toxin); NewLeaf® (potato cultivars producing the Cry3A toxin); BtXtra®, NatureGard®, KnockOut®, BiteGard®, Protecta®, Bt11 (e.g. Agrisure® CB) and Bt176 from Syngenta Seeds SAS, France, (corn cultivars producing the Cry1Ab toxin and PAT enyzme), MIR604 from Syngenta Seeds SAS, France (corn cultivars producing a modified version of the Cry3A toxin, c.f. WO 03/018810), MON 863 from Monsanto Europe S.A., Belgium (corn cultivars producing the Cry3Bb1 toxin), IPC 531 from Monsanto Europe S.A., Belgium (cotton cultivars producing a modified version of the Cry1Ac toxin) and 1507 from Pioneer Overseas Corporation, Belgium (corn cultivars producing the Cry1F toxin and PAT enzyme).

Furthermore, plants are also covered that, by the use of recombinant DNA techniques, are capable to synthesize one or more proteins to increase the resistance or tolerance of those plants to bacterial, viral or fungal pathogens. Examples of such proteins are the so-called “pathogenesis-related proteins” (PR proteins, see, e.g. EP-A 392 225), plant disease resistance genes (e.g. potato cultivars, which express resistance genes acting against Phytophthora infestans derived from the Mexican wild potato Solanum bulbocastanum) or T4-lysozym (e.g. potato cultivars capable of synthesizing these proteins with increased resistance against bacteria such as Erwinia amylvora). The methods for producing such genetically modified plants are generally known to the person skilled in the art and are described, e.g., in the publications mentioned above.

Furthermore, plants are also covered that, by the use of recombinant DNA techniques, are capable to synthesize one or more proteins to increase the productivity (e.g. bio mass production, grain yield, starch content, oil content or protein content), tolerance to drought, salinity or other growth-limiting environmental factors or tolerance to pests and fungal, bacterial or viral pathogens of those plants.

Furthermore, plants are also covered that, by the use of recombinant DNA techniques, contain a modified amount of substances of content or new substances of content, specifically to improve human or animal nutrition, e.g. oil crops that produce health-promoting long-chain omega-3 fatty acids or unsaturated omega-9 fatty acids (e.g. Nexera® rape, DOW Agro Sciences, Canada).

Furthermore, plants are also covered that, by the use of recombinant DNA techniques, contain a modified amount of substances of content or new substances of content, specifically to improve raw material production, e.g. potatoes that produce increased amounts of amylopectin (e.g. Amflora® potato, BASF SE, Germany).

### Specifically, in the Method of the Invention

the biological control agent is Bacillus subtilis strain QST 713, the synthetic fungicide is boscalid and the plant to be treated is grape, stonefruit, bean or lettuce; or
the biological control agent is Bacillus subtilis strain QST 713, the synthetic fungicide is metrafenone and the plant to be treated is grape, melon, pepper, cucurbit or cucumber; or
the biological control agent is Bacillus subtilis strain QST 713, the synthetic fungicide is dithianon and the plant to be treated is grape or pome fruit (specifically apple); or
the biological control agent is Bacillus subtilis strain QST 713, the synthetic fungicide is 5-ethyl-6-octyl-[1,2,4]triazolo[1,5-a]pyrimidine-7-ylamine and the plant to be treated is cucurbit; or
the biological control agent is Bacillus subtilis strain QST 713, the synthetic fungicide is pyraclostrobin and the plant to be treated is sugar beet; or
the biological control agent is Bacillus subtilis strain QST 713, the synthetic fungicide is fludioxonil and the plant to be treated is bean; or
the biological control agent is Bacillus subtilis strain QST 713, the synthetic fungicide is cyprodinil and the plant to be treated is bean; or
the biological control agent is Bacillus subtilis strain QST 713, the synthetic fungicide is difenoconazole and the plant to be treated is carrot; or
the biological control agent is Bacillus subtilis strain QST 713, the synthetic fungicide is a combination of pyraclostrobin and boscalid, specifically a mixture of pyreclostrobin and boscalid, and the plant to be treated is tomato, cabbage or carrot; or
the biological control agent is Bacillus subtilis strain QST 713, the synthetic fungicide is metiram and the plant to be treated is grape; or
the biological control agent is Bacillus subtilis strain QST 713, the synthetic fungicide is pyrimethanil and the plant to be treated is pome fruit (specifically apple); or
the biological control agent is Bacillus subtilis strain QST 713, the synthetic fungicide is kresoxim-methyl and the plant to be treated is grape; or
the biological control agent is Bacillus subtilis strain QST 713, the synthetic fungicide is a combination of pyrimethanil and dithianon, specifically a mixture of pyrimethanil and dithianon, and the plant to be treated is pome fruit; or
the biological control agent is Bacillus subtilis strain QST 713, the synthetic fungicide is a combination of pyraclostrobin and dithianon, specifically a mixture of pyraclostrobin and dithianon, and the plant to be treated is pome fruit (specifically apple); or
the biological control agent is Bacillus subtilis strain QST 713, the synthetic fungicide is a combination of boscalid and kresoxim-methyl, specifically a mixture of boscalid and kresoxim-methyl, and the plant to be treated is grape; or
the biological control agent is Bacillus subtilis strain QST 713, the synthetic fungicide is a combination of pyraclostrobin and metiram, specifically a mixture of pyraclostrobin and metiram, and the plant to be treated is grape; or
the biological control agent is Bacillus subtilis strain QST 713, the synthetic fungicide is a combination of dithianon, pyrimethanil and pyraclostrobin, specifically a combination of dithianon, a mixture of dithianon and pyrimethanil and a mixture of dithianon and pyraclostrobin, and the plant to be treated is pome fruit (specifically apple); or
the biological control agent is Bacillus subtilis strain QST 713, the synthetic fungicide is a combination of metrafenone, boscalid and kresoxim-methyl, specifically a combination of metrafenone and a mixture of boscalid and kresoxim-methyl, and the plant to be treated is grape; or
the biological control agent is Bacillus subtilis strain QST 713, the synthetic fungicide is a combination of metrafenone, pyraclostrobin, metiram and boscalid, specifically a combination of metrafenone, a mixture of pyraclostrobin and metiram, and boscalid, and the plant to be treated is grape; or
the biological control agent is Bacillus subtilis strain QST 713, the synthetic fungicide is a combination of boscalid, fludioxonil and cyprodinil, specifically a combination of boscalid and a mixture of fludioxonil and cyprodinil, and the plant to be treated is bean; or
the biological control agent is Bacillus subtilis strain QST 713, the synthetic fungicide is a combination of difenoconazole, boscalid and pyraclostrobin, specifically a combination of difenoconazole and a mixture of boscalid and pyraclostrobin, and the plant to be treated is carrot; or
the biological control agent is an extract of Reynoutria sachalinensis, the synthetic fungicide is metrafenone and the plant to be treated is grape or cucurbit.

If the synthetic fungicide in the above list of the specifically embodiment of the method of the invention is a “combination” of several synthetic fungicides, this means that the treatment block comprises the subsequent application of the different fungicides/fungicidal mixtures listed. However, the order given in the list is not mandatory and the treatment step may comprise more than one application of the fungicides/fungicidal mixtures listed.

The combined used of synthetic fungicides and BCAs according to the invention is distinguished by an outstanding effectiveness against a broad spectrum of phytopathogenic fungi, including soil-borne fungi, which derive especially from the classes of the Plasmodiophoromycetes, Peronosporomycetes (syn. Oomycetes), Chytridiomycetes, Zygomycetes, Ascomycetes, Basidiomycetes and Deuteromycetes (syn. Fungi imperfecti). Advantageously, the method of the invention is suitable for controlling the following plant diseases:

Albugo spp. (white rust) on ornamentals, vegetables (e.g. A. candida) and sunflowers (e.g. A. tragopogonis); Alternaria spp. (Alternaria leaf spot) on vegetables, rape, cabbage (A. brassicola or brassicae), sugar beets (A. tenuis), fruits, rice, soybeans, potatoes (e.g. A. solani or A. alternata), tomatoes (e.g. A. solani or A. alternata), carrots (A. dauci) and wheat; Aphanomyces spp. on sugar beets and vegetables; Ascochyta spp. on cereals and vegetables, e.g. A. tritici (anthracnose) on wheat and A. hordei on barley; Bipolaris and Drechslera spp. (teleomorph: Cochliobolus spp.), e.g. Southern leaf blight (D. maydis) or Northern leaf blight (B. zeicola) on corn, e.g. spot blotch (B. sorokiniana) on cereals and e.g. B. oryzae on rice and turfs; Blumeria (formerly Erysiphe) graminis (powdery mildew) on cereals (e.g. on wheat or barley); Botrytis cinerea (teleomorph: Botryotinia fuckeliana: grey mold) on fruits and berries (e.g. strawberries), vegetables (e.g. lettuce, carrots, celery and cabbages), rape, flowers, vines, forestry plants and wheat; Bremia lactucae (downy mildew) on lettuce; Ceratocystis (syn. Ophiostoma) spp. (rot or wilt) on broad-leaved trees and evergreens, e.g. C. ulmi (Dutch elm disease) on elms; Cercospora spp. (Cercospora leaf spots) on corn (e.g. Gray leaf spot: C. zeae-maydis), rice, sugar beets (e.g. C. beticola), sugar cane, vegetables, coffee, soybeans (e.g. C. sojina or C. kikuchii) and rice; Cladosporium spp. on tomatoes (e.g. C. fulvum: leaf mold) and cereals, e.g. C. herbarum (black ear) on wheat; Claviceps purpurea (ergot) on cereals; Cochliobolus (anamorph: Helminthosporium of Bipolaris) spp. (leaf spots) on corn (C. carbonum), cereals (e.g. C. sativus, anamorph: B. sorokiniana) and rice (e.g. C. miyabeanus, anamorph: H. oryzae); Colictotrichum (teleomorph: Glomerella) spp. (anthracnose) on cotton (e.g. C. gossypii), corn (e.g. C. graminicola: Anthracnose stalk rot), soft fruits, potatoes (e.g. C. coccodes: black dot), beans (e.g. C. lindemuthianum) and soybeans (e.g. C. truncatum or C. gloeosporioides); Corticium spp., e.g. C. sasakii (sheath blight) on rice; Corynespora cassiicola (leaf spots) on soybeans and ornamentals; Cycloconium spp., e.g. C. oleaginum on olive trees; Cylindrocarpon spp. (e.g. fruit tree canker or young vine decline, teleomorph: Nectria or Neonectria spp.) on fruit trees, vines (e.g. C. liriodendri, teleomorph: Neonectria liriodendri: Black Foot Disease) and ornamentals; Dematophora (teleomorph: Rosellinia) necatrix (root and stem rot) on soybeans; Diaporthe spp., e.g. D. phaseolorum (damping off) on soybeans; Drechslera (syn. Helminthosporium, teleomorph: Pyrenophora) spp. on corn, cereals, such as barley (e.g. D. teres, net blotch) and wheat (e.g. D. tritici-repentis: tan spot), rice and turf; Esca (dieback, apoplexy) on vines, caused by Formitiporia (syn. Phellinus) punctata, F. mediterranea, Phaeomoniella chlamydospora (earlier Phaeoacremonium chlamydosporum), Phaeoacremonium aleophilum and/or Botryosphaeria obtusa; Elsinoe spp. on pome fruits (E. pyri), soft fruits (E. veneta: anthracnose) and vines (E. ampelina: anthracnose); Entyloma oryzae (leaf smut) on rice; Epicoccum spp. (black mold) on wheat; Erysiphe spp. (powdery mildew) on carrots, sugar beets (E. betae), vegetables (e.g. E. pisi), such as cucurbits (e.g. E. cichoracearum), cabbages, rape (e.g. E. cruciferarum); Eutypa lata (Eutypa canker or dieback, anamorph: Cytosporina lata, syn. Libertella blepharis) on fruit trees, vines and ornamental woods; Exserohilum (syn. Helminthosporium) spp. on corn (e.g. E. turcicum); Fusarium (teleomorph: Gibberella) spp. (wilt, root or stem rot) on various plants, such as F. graminearum or F. culmorum (root rot, scab or head blight) on cereals (e.g. wheat or barley), F. oxysporum on tomatoes, F. solani on soybeans and F. verticillioides on corn; Gaeumannomyces graminis (take-all) on cereals (e.g. wheat or barley) and corn; Gibberella spp. on cereals (e.g. G. zeae) and rice (e.g. G. fujikuroi: Bakanae disease); Glomerella cingulata on vines, pome fruits and other plants and G. gossypii on cotton; Grainstaining complex on rice; Guignardia bidwellii (black rot) on vines; Gymnosporangium spp. on rosaceous plants and junipers, e.g. G. sabinae (rust) on pears; Helminthosporium spp. (syn. Drechslera, teleomorph: Cochliobolus) on corn, cereals and rice; Hemileia spp., e.g. H. vastatrix (coffee leaf rust) on coffee; Isariopsis clavispora (syn. Cladosporium vitis) on vines; Leveillula taurica on pepper, Macrophomina phaseolina (syn. phaseoli) (root and stem rot) on soybeans and cotton; Microdochium (syn. Fusarium) nivale (pink snow mold) on cereals (e.g. wheat or barley); Microsphaera diffusa (powdery mildew) on soybeans; Monilinia spp., e.g. M. taxa, M. fructicola and M. fructigena (bloom and twig blight, brown rot) on stone fruits and other rosaceous plants; Mycosphaerella spp. on cereals, bananas, soft fruits and ground nuts, such as e.g. M. graminicola (anamorph: Septoria tritici, Septoria blotch) on wheat or M. fijiensis (black Sigatoka disease) on bananas; Peronospora spp. (downy mildew) on cabbage (e.g. P. brassicae), rape (e.g. P. parasitica), onions (e.g. P. destructor), tobacco (P. tabacina) and soybeans (e.g. P. manshurica); Phakopsora pachyrhizi and P. meibomiae (soybean rust) on soybeans; Phialophora spp. e.g. on vines (e.g. P. tracheiphila and P. tetraspora) and soybeans (e.g. P. gregata: stem rot); Phoma lingam (root and stem rot) on rape and cabbage and P. betae (root rot, leaf spot and damping-off) on sugar beets; Phomopsis spp. on sunflowers, vines (e.g. P. viticola: can and leaf spot) and soybeans (e.g. stem rot: P. phaseoli, teleomorph: Diaporthe phaseolorum); Physoderma maydis (brown spots) on corn; Phytophthora spp. (wilt, root, leaf, fruit and stem root) on various plants, such as paprika and cucurbits (e.g. P. capsid), soybeans (e.g. P. megasperma, syn. P. sojae), potatoes and tomatoes (e.g. P. infestans: late blight) and broad-leaved trees (e.g. P. ramorum: sudden oak death); Plasmodiophora brassicae (club root) on cabbage, rape, radish and other plants; Plasmopara spp., e.g. P. viticola (grapevine downy mildew) on vines and P. halstedii on sunflowers; Podosphaera spp. (powdery mildew) on rosaceous plants, hop, pome and soft fruits, e.g. P. leucotricha on apples; Polymyxa spp., e.g. on cereals, such as barley and wheat (P. graminis) and sugar beets (P. betae) and thereby transmitted viral diseases; Pseudocercosporella herpotrichoides (eyespot, teleomorph: Tapesia yallundae) on cereals, e.g. wheat or barley; Pseudoperonospora (downy mildew) on various plants, e.g. P. cubensis on cucurbits or P. humili on hop; Pseudopezicula tracheiphila (red fire disease or, rotbrenner', anamorph: Phialophora) on vines; Puccinia spp. (rusts) on various plants, e.g. P. triticina (brown or leaf rust), P. striiformis (stripe or yellow rust), P. hordei (dwarf rust), P. graminis (stem or black rust) or P. recondita (brown or leaf rust) on cereals, such as e.g. wheat, barley or rye, and asparagus (e.g. P. asparagi); Pyrenophora (anamorph: Drechslera) tritici-repentis (tan spot) on wheat or P. teres (net blotch) on barley; Pyricularia spp., e.g. P. oryzae (teleomorph: Magnaporthe grisea, rice blast) on rice and P. grisea on turf and cereals; Pythium spp. (damping-off) on turf, rice, corn, wheat, cotton, rape, sunflowers, soybeans, sugar beets, vegetables and various other plants (e.g. P. ultimum or P. aphanidermatum); Ramularia spp., e.g. R. collo-cygni (Ramularia leaf spots, Physiological leaf spots) on barley and R. beticola on sugar beets; Rhizoctonia spp. on cotton, rice, potatoes, turf, corn, rape, potatoes, sugar beets, vegetables and various other plants, e.g. R. solani (root and stem rot) on soybeans, R. solani (sheath blight) on rice or R. cerealis (Rhizoctonia spring blight) on wheat or barley; Rhizopus stolonifer (black mold, soft rot) on strawberries, carrots, cabbage, vines and tomatoes; Rhynchosporium secalis (scald) on barley, rye and triticale; Sarocladium oryzae and S. attenuatum (sheath rot) on rice; Sclerotinia spp. (stem rot or white mold) on vegetables and field crops, such as rape, bean, sunflowers (e.g. S. sclerotiorum) and soybeans (e.g. S. rolfsii or S. sclerotiorum); Septoria spp. on various plants, e.g. S. glycines (brown spot) on soybeans, S. tritici (Septoria blotch) on wheat and S. (syn. Stagonospora) nodorum (Stagonospora blotch) on cereals; Uncinula (syn. Erysiphe) necator (powdery mildew, anamorph: Oidium tuckeri) on vines; Setospaeria spp. (leaf blight) on corn (e.g. S. turcicum, syn. Helminthosporium turcicum) and turf; Sphacelotheca spp. (smut) on corn, (e.g. S. reiliana: head smut), sorghum and sugar cane; Sphaerotheca fuliginea (powdery mildew) on cucurbits, cucumbers and melons; Spongospora subterranea (powdery scab) on potatoes and thereby transmitted viral diseases; Stagonospora spp. on cereals, e.g. S. nodorum (Stagonospora blotch, teleomorph: Leptosphaeria [syn. Phaeosphaeria] nodorum) on wheat; Synchytrium endobioticum on potatoes (potato wart disease); Taphrina spp., e.g. T. deformans (leaf curl disease) on peaches and T. pruni (plum pocket) on plums; Thielaviopsis spp. (black root rot) on tobacco, pome fruits, vegetables, soybeans and cotton, e.g. T. basicola (syn. Chalara elegans); Tilletia spp. (common bunt or stinking smut) on cereals, such as e.g. T. tritici (syn. T. caries, wheat bunt) and T. controversa (dwarf bunt) on wheat; Typhula incarnate (grey snow mold) on barley or wheat; Urocystis spp., e.g. U. occulta (stem smut) on rye; Uromyces spp. (rust) on vegetables, such as beans (e.g. U. appendiculatus, syn. U. phaseoli) and sugar beets (e.g. U. betae); Ustilago spp. (loose smut) on cereals (e.g. U. nuda and U. avaenae), corn (e.g. U. maydis: corn smut) and sugar cane; Venturia spp. (scab) on apples (e.g. V. inaequalis) and pears; and Verticillium spp. (wilt) on various plants, such as fruits and ornamentals, vines, soft fruits, vegetables and field crops, e.g. V. dahliae on strawberries, rape, potatoes and tomatoes.

Specifically, the method of the invention is used for controlling following plant pathogens:
Botrytis cinerea (teleomorph: Botryotinia fuckeliana: grey mold) on fruits and berries (e.g. strawberries), vegetables (e.g. lettuce, carrots, celery and cabbages), rape, flowers, grapes (vines), forestry plants and wheat and especially on grapes
Bremia lactucae (downy mildew) on lettuce
Uncinula (syn. Erysiphe) necator (powdery mildew, anamorph: Oidium tuckeri) on grapes (vines)
Plasmopara spp., e.g. P. viticola (grapevine downy mildew) on grapes (vines) and P. halstedii on sunflowers, especially P. viticola on grapes
Pseudoperonospora (downy mildew) on various plants, e.g. P. cubensis on cucurbits or P. humili on hop, especially P. cubensis on cucurbits
Alternaria spp. (Alternaria leaf spot) on vegetables, rape (A. brassicola or brassicae), cabbage (A. brassicae), sugar beets (A. tenuis), fruits, rice, soybeans, potatoes (e.g. A. solani or A. alternata), tomatoes (e.g. A. solani or A. alternata), carrots (A. dauci) and wheat, especially A. solani on tomatoes, A. brassicae on cabbage and A. dauci on carrots.
Venturia spp. (scab) on apples (e.g. V. inaequalis) and pears, especially V. inaequalis on pomefruit, especially apple
Monilinia spp., e.g. M. taxa, M. fructicola and M. fructigena (bloom and twig blight, brown rot) on stone fruits and other rosaceous plants, especially M. taxa on stone fruit
Cercospora spp. (Cercospora leaf spots) on corn (e.g. Gray leaf spot: C. zeae-maydis), rice, sugar beets (e.g. C. beticola), sugar cane, vegetables, coffee, soybeans (e.g. C. sojina or C. kikuchii) and rice, especially C. beticola on sugar beets
Erysiphe spp. (powdery mildew) on carrots or on sugar beets (E. betae)
Sphaerotheca fuliginea (powdery mildew) on cucurbits, cucumber and melons
Leveillula taurica on pepper
Sclerotinia spp. (stem rot or white mold) on vegetables and field crops, such as rape, sunflowers, beans (e.g. S. sclerotiorum) and soybeans (e.g. S. rolfsii or S. sclerotiorum), especially S. sclerotiorum on beans.

The method according to the invention provides a good control of phytopathogenic fungi with no significant decline in the fungicidal effect as compared to the results obtained with the application of a synthetic fungicide alone. In many cases, the fungicidal effect of the method of the invention is comparable, in some cases even better than the effect of the synthetic fungicide alone. In some cases, the fungicidal effect is enhanced even overadditively (synergistically; synergism calculated according to Colby's formula) Advantageously, the residual amount of the synthetic fungicides in the harvested crops is significantly diminished as compared to plants which have been treated with the respective synthetic fungicide alone.

The invention will now be further illustrated by the following, non-limiting examples.

### EXAMPLES

The active compounds were used as a commercial formulation

Evaluation was carried out by visually determining the infected leaf areas in %.

1. Activity of B. subtilis Strain QST 713 in Combination with Boscalid Against Botrytis cinerea in Grapes

Vine grapes of the cultivar “Riesling” were grown under standard conditions with adequate supply of water and nutrients. The test plants were inoculated with an aqueous spore suspension of Botrytis cinerea. On the dates compiled in table 1 below, the plants' leaves were sprayed to runoff point with an aqueous formulation having the concentration of active compound stated below. For comparison, a part of the plants was sprayed with boscalid alone (used as the commercial product Cantus®, BASF; dose rate per treatment: 1.2 kg/ha; diluted with water to 800 l/ha). Another part was sprayed both with boscalid and B. subtilis strain QST 713 (used as the commercial product Serenade® AS, from AGRAQUEST; dose rate per treatment: 8 l/ha, diluted with water to 800 l/ha). 95 and 100 days after the first treatment (25 or 30 days after last treatment), the extent of the development of the disease was determined visually in % infection of the racemes. The results are compiled in table 1 below.

TABLE 1

| | Application | Attack on raceme [%] | |
|---|---|---|---|
| Treatment | code | 95 DAT* | 100 DAT* |
| Control | — | 41 | 55 |
| Boscalid | AB | 35 | 44 |
| Boscalid | ABC | 28 | 36 |
| Boscalid | AB | 21 | 32 |
| B. subtilis QST 713 | CDE | | |
| Boscalid | ABC | 17 | 26 |
| B. subtilis QST 713 | DE | | |

*DAT = Days after first treatment

### Application Code:

| Application code | Application date | Growth stage |
|---|---|---|
| A | 09 Jun. 2008 | 68 |
| B | 05 Jul. 2008 | 77 |
| C | 07 Aug. 2008 | 81 |
| D | 18 Aug. 2008 | 83 |
| E | | |

2. Activity of B. subtilis Strain QST 713 in Combination with Metrafenone Against Uncinula necator in Grapes

Vine grapes were grown under standard conditions with adequate supply of water and nutrients. The test plants were inoculated with an aqueous spore suspension of Uncinula necator. On the dates compiled in table 2 below, the plants' leaves were sprayed to runoff point with an aqueous formulation having the concentration of active compound stated below. For comparison, a part of the plants was sprayed with metrafenone alone (used as the commercial product Vivando®, BASF; dose rate per treatment: 0.02 Vol.-%; diluted with water to 800 l/ha). Another part was sprayed both with metrafenone and B. subtilis strain QST 713 (used as the commercial product Serenade® AS, from AGRAQUEST; dose rate per treatment: 8 l/ha, diluted with water to 800 l/ha). 85 and 91 days after the first treatment (15 or 21 days after last treatment), the extent of the development of the disease was determined visually in % infection of the racemes. The results are compiled in table 2 below.

TABLE 2

| | Application | Attack on raceme [%] | |
|---|---|---|---|
| Treatment | code | 85 DAT* | 91 DAT* |
| Control | — | 63 | 70 |
| Metrafenone | ABC | 26 | 32 |
| Metrafenone | ABCD | 11 | 14 |
| Metrafenone | ABC | 9 | 12 |
| B. subtilis QST 713 | DEF | | |
| Metrafenone | ABCD | 7 | 10 |
| B. subtilis QST 713 | EF | | |

*DAT = Days after first treatment

### Application Code:

| Application code | Application date | Growth stage |
|---|---|---|
| A | 28 May 2008 | 57 |
| B | 11 Jun. 2008 | 65 |
| C | 25 Jun. 2008 | 73 |
| D | 09 Jul. .2008 | 77 |
| E | 23 Jul. 2008 | 79 |
| F | 06 Aug. 2008 | 81 |

3. Activity of B. subtilis Strain QST 713 in Combination with Dithianon Against Plasmopara viticola in Grapes

Vine grapes were grown under standard conditions with adequate supply of water and nutrients. The test plants were inoculated with an aqueous spore suspension of Plasmopara viticola. On the dates compiled in table 3 below, the plants' leaves were sprayed to runoff point with an aqueous formulation having the concentration of active compound stated below. For comparison, a part of the plants was sprayed with dithianon alone (used as the commercial product Delan® WG, Bayer; dose rate per treatment: 525 g/ha; diluted with water to 800 l/ha) or with B. subtilis strain QST 713 alone (used as the commercial product Serenade® AS, from AGRAQUEST; dose rate per treatment: 8 l/ha, diluted with water to 800 l/ha). Another part was sprayed both with dithianon and B. subtilis strain QST 713. 67 and 73 days after the first treatment (4 or 10 days after last treatment), the extent of the development of the disease was determined visually in % infection of the racemes. 73 days after the first treatment (10 days after last treatment), the severity and the frequency of the infection on the racemes were determined visually [%]. 87 days after the first treatment (14 days after last treatment), the extent of the development of the disease was determined visually in % infection of the leaves. The results are compiled in table 3 below.

TABLE 3

| | | Attack on | | Frequency | Sever- | Attack on |
|---|---|---|---|---|---|---|
| | Application | raceme [%] | | [%] | ity [%] | leaves [%] |
| Treatment | code | 67 DAT* | 73 DAT | 73 DAT | 73 DAT | 87 DAT |
| Control | — | 87 | 93 | 94 | 58 | 80 |
| Dithianon | ABCDEFGHI | 34 | 48 | 37 | 7.5 | 25 |
| B. subtilis | ABCDEFGHI | 79 | 87 | 86 | 38 | 70 |
| QST 713 | | | | | | |
| Dithianon | ABCD | 27 | 34 | 32 | 6.0 | 25 |
| B. subtilis | EFGHI | | | | | |
| QST 713 | | | | | | |
| Dithianon | ABCDE | 20 | 24 | 32 | 4.5 | 14 |
| B. subtilis | FGHI | | | | | |
| QST 713 | | | | | | |

*DAT = Days after first treatment

### Application Code:

| Application code | Application date | Growth stage |
|---|---|---|
| A | 16 May 2008 | 53 |
| B | 28 May 2008 | 57 |
| C | 04 Jun. 2008 | 63 |
| D | 13 Jun. 2008 | 68 |
| E | 23 Jun. 2008 | 71 |
| F | 04 Jul. 2008 | 75 |
| G | 18 Jul. 2008 | 79 |
| H | 29 Jul. 2008 | 79 |
| I | 07 Aug. 2008 | 81 |

4. Activity of B. subtilis Strain QST 713 in Combination with 5-ethyl-6-octyl-[1,2,4]triazolo[1,5-a]pyrimidine-7-ylamine (“BAS 650”) against Pseudoperonospora cubensis in Cucurbits

Cucurbits were cultivated and grown under standard conditions with adequate supply of water and nutrients. The test plants were inoculated with an aqueous spore suspension of Pseudoperonospora cubensis. On the dates compiled in table 4 below, the plants' leaves were sprayed to runoff point with an aqueous formulation having the concentration of active compound stated below. For comparison, a part of the plants was sprayed with 5-ethyl-6-octyl-[1,2,4]triazolo[1,5-a]pyrimidine-7-ylamine alone (“BAS 650”; used as the commercial product BAS 650 00F®, BASF; dose rate per treatment: 1.2 l/ha; diluted with water to 500 l/ha) or with B. subtilis strain QST 713 alone (used as the commercial product Serenade® AS, from AGRAQUEST; dose rate per treatment: 8 l/ha, diluted with water to 500 l/ha). Another part was sprayed both with 5-ethyl-6-octyl-[1,2,4]triazolo[1,5-a]pyrimidine-7-ylamine and B. subtilis strain QST 713. 28 days after the first treatment (6 days after last treatment), the extent of the development of the disease was determined visually in % infection of the leaves. The results are compiled in table 4 below.

TABLE 4

| Treatment | Application code | Attack on leaves [%] |
|---|---|---|
| Control | — | 8.3 |
| BAS 650 | AB | 7 |
| BAS 650 | ABC | 6.2 |
| B. subtilis QST 713 | ABCDE | 8.5 |
| BAS 650 | AB | 6 |
| B. subtilis QST 713 | CDE | |

*DAT = Days after first treatment

### Application Code:

| Application code | Application date | Growth stage |
|---|---|---|
| A | 27 Feb. 2008 | 61 |
| B | 05 Mar. 2008 | 63 |
| C | 13 Mar. 2008 | 71 |
| D | 20 Mar. 2008 | 75 |
| E | 27 Mar. 2008 | 81 |

5. Activity of B. subtilis Strain QST 713 in Combination with Pyraclostrobin and Boscalid Against Alternaria solani in Tomatoes

Tomatoes were cultivated and grown under standard conditions with adequate supply of water and nutrients. The test plants were inoculated with an aqueous spore suspension of Alternaria solani. On the dates compiled in table 5 below, the plants' leaves were sprayed to runoff point with an aqueous formulation having the concentration of active compound stated below. For comparison, a part of the plants was sprayed with a mixture of pyraclostrobin and boscalid alone (used as the commercial product Signum®, BASF; dose rate per treatment: 300 g/ha; diluted with water to 500 l/ha). Another part was sprayed both with the pyraclostrobin/boscalid mixture and B. subtilis strain QST 713 (used as the commercial product Serenade® AS, from AGRAQUEST; dose rate per treatment: 8 l/ha, diluted with water to 500 l/ha). 42 and 55 days after the first treatment (14 or 21 days after last treatment), the extent of the development of the disease was determined visually in % infection of the upper third of the plant. The results are compiled in table 5 below.

TABLE 5

| | Application | Attack on upper third of plant [%] | |
|---|---|---|---|
| Treatment | code | 42 DAT* | 55 DAT* |
| Control | — | 34 | 22 |
| Pyraclostrobin/Boscalid | ABC | 3.1 | 3.9 |
| Pyraclostrobin/Boscalid | ABC | 2.5 | 3.3 |
| B. subtilis QST 713 | DE | | |

*DAT = Days after first treatment

### Application Code:

| Application code | Application date |
|---|---|
| A | 04 Dec. 2007 |
| B | 11 Dec. 2007 |
| C | 18 Dec. 2007 |
| D | 25 Dec. 2007 |
| E | 30 Dec. 2007 |

6. Activity of B. subtilis Strain QST 713 in Combination with Pyraclostrobin and Boscalid Against Alternaria brassicae in Cabbage

Cabbage was cultivated and grown under standard conditions with adequate supply of water and nutrients. The test plants were inoculated with an aqueous spore suspension of Alternaria brassicae. On the dates compiled in table 6 below, the plants' leaves were sprayed to runoff point with an aqueous formulation having the concentration of active compound stated below. For comparison, a part of the plants was sprayed with a mixture of pyraclostrobin and boscalid alone (used as the commercial product Signum®, BASF; dose rate per treatment: 200 g/ha; diluted with water to 500 l/ha) or with B. subtilis strain QST 713 alone (used as the commercial product Serenade® AS, from AGRAQUEST; dose rate per treatment: 8 l/ha, diluted with water to 500 l/ha). Another part was sprayed both with the pyraclostrobin/boscalid mixture and B. subtilis strain QST 713. 27 and 35 days after the first treatment (7 or 15 days after last treatment), the extent of the development of the disease was determined visually in % infection of the plant. The results are compiled in table 6 below.

TABLE 6

| | Application | Attack on plant [%[ | |
|---|---|---|---|
| Treatment | code | 27 DAT* | 35 DAT* |
| Control | — | 25 | 42 |
| Pyraclostrobin/Boscalid | A | 6 | 24 |
| Pyraclostrobin/Boscalid | AB | 1 | 10 |
| B. subtilis QST 713 | ABCD | 11 | 17 |
| Pyraclostrobin/Boscalid | A | 0.7 | 8.3 |
| B. subtilis QST 713 | BC | | |
| Pyraclostrobin/Boscalid | AB | 0.4 | 5.2 |
| B. subtilis QST 713 | CD | | |

*DAT = Days after first treatment

### Application Code:

| Application code | Application date | Growth stage |
|---|---|---|
| A | 28 Mar. 2008 | 31 |
| B | 07 Apr. 2008 | 41 |
| C | 17 Apr. 2008 | 43 |
| D | 28 Apr. 2008 | 65 |

7. Activity of B. subtilis Strain QST 713 in Combination with Boscalid and Pyraclostrobin Against Monilinia laxa in Stonefruit

Stonefruit was grown under standard conditions with adequate supply of water and nutrients. The test plants were inoculated with an aqueous spore suspension of Monilinia laxa. On the dates compiled in table 7 below, the plants' leaves were sprayed to runoff point with an aqueous formulation having the concentration of active compound stated below. For comparison, a part of the plants was sprayed with a mixture of pyraclostrobin and boscalid alone (used as the commercial product Pristine®, BASF; dose rate per treatment: 0.66 g/ha; diluted with water to 500 l/ha) or with B. subtilis strain QST 713 alone (used as the commercial product Serenade® AS, from AGRAQUEST; dose rate per treatment: 8 l/ha, diluted with water to 500 l/ha). Another part was sprayed both with boscalid and B. subtilis strain QST 713. 5 and 11 days after the first treatment (0 or 6 days after last treatment), the extent of the development of the disease was determined visually in % infection of the plant. The results are compiled in table 7 below.

TABLE 7

| | Application | Attack on plant [%] | |
|---|---|---|---|
| Treatment | code | 5 DAT* | 11 DAT* |
| Control | — | 75 | 100 |
| Boscalid | A | 1.8 | 36 |
| Boscalid | AB | 1.8 | 29 |
| B. subtilis QST 713 | AB | 4.0 | 70 |
| Boscalid | A | 1.3 | 14 |
| B. subtilis QST 713 | B | | |

*DAT = Days after first treatment

### Application Code:

| Application code | Application date | Growth stage |
|---|---|---|
| A | 20 Feb. 2008 | 66 |
| B | 25 Feb. 2008 | 67 |

8. Activity of B. subtilis Strain QST 713 in Combination with Pyraclostrobin Against Cercospora beticola in Sugar Beets

Sugar beets were cultivated and grown under standard conditions with adequate supply of water and nutrients. The test plants were inoculated with an aqueous spore suspension of Cercospora beticola. On the dates compiled in table 8 below, the plants' leaves were sprayed to runoff point with an aqueous formulation having the concentration of active compound stated below. For comparison, a part of the plants was sprayed with pyraclostrobin alone (used as the commercial product Headline®, BASF; dose rate per treatment: 0.6 l/ha; diluted with water to 400 l/ha). Another part was sprayed both with pyraclostrobin and B. subtilis strain QST 713 (used as the commercial product Serenade® AS, from AGRAQUEST; dose rate per treatment: 8 l/ha, diluted with water to 400 l/ha). 46 and 53 days after the first treatment (7 or 14 days after last treatment), the extent of the development of the disease was determined visually in % infection of the plant. The results are compiled in table 8 below.

TABLE 8

| | Application | Attack on plant [%] | |
|---|---|---|---|
| Treatment | code | 46 DAT* | 53 DAT* |
| Control | — | 52 | 63 |
| Pyraclostrobin | A | 11 | 17 |
| Pyraclostrobin | AB | 4.7 | 5.7 |
| Pyraclostrobin | ABC | 2.7 | 3.7 |
| Pyraclostrobin | A | 3.3 | 7.0 |
| B. subtilis QST 713 | BCD | | |
| Pyraclostrobin | AB | 1.7 | 2.3 |
| B. subtilis QST 713 | CDE | | |

*DAT = Days after first treatment

### Application Code:

| Application code | Application date | Growth stage |
|---|---|---|
| A | 12 May 2008 | 46 |
| B | 21 May 2008 | 48 |
| C | 30 May 2008 | 48 |
| D | 11 Jun. 2008 | 48 |
| E | 20 Jun. 2008 | 49 |

9. Activity of B. subtilis Strain QST 713 in Combination with Metrafenone Against Sphaerotheca fuliginea in Melons

Melons were cultivated and grown under standard conditions with adequate supply of water and nutrients. The test plants were inoculated with an aqueous spore suspension of Sphaerotheca fuliginea. On the dates compiled in table 9 below, the plants' leaves were sprayed to runoff point with an aqueous formulation having the concentration of active compound stated below. For comparison, a part of the plants was sprayed with metrafenone alone (used as the commercial product Vivando®, BASF; dose rate per treatment: 0.2 l/ha; diluted with water to 500 l/ha). Another part was sprayed both with metrafenone and B. subtilis strain QST 713 (used as the commercial product Serenade® AS, from AGRAQUEST; dose rate per treatment: 8 l/ha, diluted with water to 500 l/ha). 27 and 34 days after the first treatment (1 or 8 days after last treatment), the extent of the development of the disease was determined visually in % infection of the plant. The results are compiled in table 9 below.

TABLE 9

| | Application | Attack on plant [%] | |
|---|---|---|---|
| Treatment | code | 27 DAT* | 34 DAT* |
| Control | — | 40 | 49 |
| Metrafenone | A | 24 | 32 |
| Metrafenone | AB | 9.2 | 14 |
| Metrafenone | A | 9.6 | 9.8 |
| B. subtilis QST 713 | BCE | | |
| Metrafenone | AB | 6.5 | 6.8 |
| B. subtilis QST 713 | DFG | | |

*DAT = Days after first treatment

### Application Code:

| Application code | Application date | Growth stage |
|---|---|---|
| A | 04 Dec. 2007 | 71 |
| B | 11 Dec. 2007 | 73 |
| C | 16 Dec. 2007 | 75 |
| D | 18 Dec. 2007 | 75 |
| E | 21 Dec. 2007 | 77 |
| F | 23 Dec. 2007 | 79 |
| G | 28 Dec. 2007 | 81 |

10. Activity of B. subtilis Strain QST 713 in Combination with Metrafenone Against Leveillula taurica in Peppers

Peppers were cultivated and grown under standard conditions with adequate supply of water and nutrients. The test plants were inoculated with an aqueous spore suspension of Leveillula taurica. On the dates compiled in table 10 below, the plants' leaves were sprayed to runoff point with an aqueous formulation having the concentration of active compound stated below. For comparison, a part of the plants was sprayed with metrafenone alone (used as the commercial product Vivando®, BASF; dose rate per treatment: 0.2 l/ha; diluted with water to 800 l/ha). Another part was sprayed both with metrafenone and B. subtilis strain QST 713 (used as the commercial product Serenade® AS, from AGRAQUEST; dose rate per treatment: 8 l/ha, diluted with water to 800 l/ha in sprays A and B and to 1000 l/ha in sprays C and D). 35 and 42 days after the first treatment (7 or 14 days after last treatment), the extent of the development of the disease was determined visually in % infection of the leaves. The results are compiled in table 10 below.

TABLE 10

| | Application | Attack on plant [%] | |
|---|---|---|---|
| Treatment | code | 35 DAT* | 42 DAT* |
| Control | — | 33 | 47 |
| Metrafenone | AB | 22 | 43 |
| Metrafenone | AB | 17 | 33 |
| B. subtilis QST 713 | CD | | |

*DAT = Days after first treatment

### Application Code:

| Application code | Application date |
|---|---|
| A | 16 Jun. 2008 |
| B | 23 Jun. 2008 |
| C | 30 Jun. 2008 |
| D | 07 Jul. 2008 |

11. Activity of B. subtilis Strain QST 713 in Combination with Boscalid Against Sclerotinia sclerotiorum in Beans

Beans were cultivated and grown under standard conditions with adequate supply of water and nutrients. The test plants were inoculated with an aqueous spore suspension of Sclerotinia sclerotiorum. On the dates compiled in table 11 below, the plants' leaves were sprayed to runoff point with an aqueous formulation having the concentration of active compound stated below. For comparison, a part of the plants was sprayed with boscalid alone (used as the commercial product Cantus®, BASF; dose rate per treatment: 1.0 kg/ha; diluted with water to 500 l/ha). Another part was sprayed both with boscalid and B. subtilis strain QST 713 (used as the commercial product Serenade® AS, from AGRAQUEST; dose rate per treatment: 8 l/ha, diluted with water to 500 l/ha). 28 and 35 days after the first treatment (0 or 7 days after last treatment), the extent of the development of the disease was determined visually in % infection of the plants. The results are compiled in table 11 below.

TABLE 11

| | Application | Attack on plant [%] | |
|---|---|---|---|
| Treatment | code | 28 DAT* | 35 DAT* |
| Control | — | 85 | 93 |
| Boscalid | A | 30 | 53 |
| Boscalid | A | 28 | 38 |
| B. subtilis QST 713 | BCDE | | |

*DAT = Days after first treatment

### Application Code:

| Application code | Application date | Growth stage |
|---|---|---|
| A | 19 Nov. 2007 | 65 |
| B | 23 Nov. 2007 | 71 |
| C | 29 Nov. 2007 | 73 |
| D | 04 Dec. 2007 | 73 |
| E | 10 Dec. 2007 | 75 |

12. Activity of Plant Extracts of Reynoutria sachalinensis (Milsana®) in Combination with Metrafenone Against Sphaerotheca fuliginea in Cucurbits

Cucurbits were cultivated and grown under standard conditions with adequate supply of water and nutrients. The test plants were inoculated with an aqueous spore suspension of Sphaerotheca fuliginea. On the dates compiled in table 12 below, the plants' leaves were sprayed to runoff point with an aqueous formulation having the concentration of active compound stated below. For comparison, a part of the plants was sprayed with metrafenone alone (used as the commercial product Vivando®, BASF; dose rate per treatment: 0.2 l/ha; diluted with water to 500 l/ha). Another part was sprayed both with metrafenone and plant extracts of Reynoutria sachalinensis (used as the commercial product Milsana®, from Dr. Schaette A G, Bad Waldsee, Germany; dose rate per treatment: 1 Vol-%, diluted with water to 500 l/ha). 38 days after the first treatment (6 days after last treatment), the extent of the development of the disease was determined visually in % infection of the upperside of the leaves. The results are compiled in table 12 below.

TABLE 12

| Treatment | Application code | Attack on leaves [%] |
|---|---|---|
| Control | — | 100 |
| Metrafenone | ABC | 50 |
| Metrafenone | ABC | 27 |
| Milsana ® | DE | |

*DAT = Days after first treatment

### Application Code:

| Application code | Application date |
|---|---|
| A | 02 May 2008 |
| B | 09 May 2008 |
| C | 16 May 2008 |
| D | 27 May 2008 |
| E | 03 Jun. 2008 |

13. Activity of Plant Extracts of Reynoutria sachalinensis (Milsana®) in Combination with Metrafenone Against Uncinula necator in Grapes

Grapes were grown under standard conditions with adequate supply of water and nutrients. The test plants were inoculated with an aqueous spore suspension of Uncinula necator. On the dates compiled in table 13 below, the plants' leaves were sprayed to runoff point with an aqueous formulation having the concentration of active compound stated below. For comparison, a part of the plants was sprayed with metrafenone alone (used as the commercial product Vivando®, BASF; dose rate per treatment: 0.2 l/ha; diluted with water to 1000 l/ha). Another part was sprayed both with metrafenone and plant extracts of Reynoutria sachalinensis (used as the commercial product Milsana®, from Dr. Schaette A G, Bad Waldsee, Germany; dose rate per treatment: 1 Vol-%, diluted with water to 100 l/ha). 76 and 90 days after the first treatment (14 and 28 days after last treatment), the extent of the development of the disease was determined visually in % infection of the raceme and of the leaves. The results are compiled in table 13 below.

TABLE 13

| | Application | Attack on leaves [%] | | Attack on raceme [%] | |
|---|---|---|---|---|---|
| Treatment | code | 76 DAT* | 90 DAT* | 76 DAT* | 90 DAT* |
| Control | — | 73 | 75 | 87 | 93 |
| Metrafenone | ABCDE | 4.3 | 35 | 8.3 | 43 |
| Metrafenone | ABCDEFG | 3.0 | 13 | 6.0 | 22 |
| Metrafenone | ABCDE | 3.0 | 17 | 5.7 | 22 |
| Milsana ® | FG | | | | |

*DAT = Days after first treatment

### Application Code:

| Application code | Application date | Growth stage |
|---|---|---|
| A | 15 Apr. 2008 | 55 |
| B | 25 Apr. 2008 | 55 |
| C | 05 May 2008 | 61 |
| D | 15 May 2008 | 73 |
| E | 26 May 2008 | 73 |
| F | 05 Jun. 2008 | 79 |
| G | 16 Jun. 2008 | 81 |

14. Activity of B. subtilis Strain QST 713 in Combination with Pyraclostrobin and Boscalid Against Alternaria solani (ALTESO) in Tomatoes

The trial was conducted under field conditions. Tomato seedlings were transplanted to the field and grown under standard conditions with adequate supply of water and nutrients. Before disease onset the first application of the products listed in Table 14 below was made. The application was repeated 2 to 4 times (see below) with 7 to 9 days intervals applying single products. No other products or compounds were applied for pathogen control. For this purpose, the plants' leaves were sprayed to runoff point with an aqueous formulation having the concentration of active compound stated below. For comparison, a part of the plants was sprayed with a mixture of pyraclostrobin and boscalid alone (used as the commercial product Signum®, BASF; dose rate per treatment: 300 g/ha; diluted with water to 500 l/ha). Also for comparison, a part of the plants was sprayed with B. subtilis strain QST 713 (used as the commercial product Serenade® ASO, from AGRAQUEST; dose rate per treatment: 8 l/ha, diluted with water to 500 l/ha). Another part was sprayed both with the pyraclostrobin/boscalid mixture and B. subtilis strain QST 713 (used as the commercial product Serenade® ASO, from AGRAQUEST; dose rate per treatment: 8 l/ha, diluted with water to 500 l/ha). ALTESO infection occurred naturally. Disease incidences were evaluated 13 days after 4^{th} application (13 DAT(4)). Disease levels observed were rated in percent infected leaf area in the respective plot given as % attack.

TABLE 14

| | Application | Attacked leaf area [%] |
|---|---|---|
| Treatment | code | 13 DAT(4) |
| Control | — | 61 |
| Pyraclostrobin/Boscalid | AB | 4.4 |
| Pyraclostrobin/Boscalid | ABC | 2.1 |
| B. subtilis QST 713 | ABCD | 18 |
| Pyraclostrobin/Boscalid | AB | 2.4 |
| B. subtilis QST 713 | CD | |

### Application Code:

| Application code | Application date | Growth stage |
|---|---|---|
| A | 25 Nov. 2008 | 23 |
| B | 2 Dec. 2008 | 62 |
| C | 9 Dec. 2008 | 72 |
| D | 18 Dec. 2008 | 74 |

15. Activity of B. subtilis Strain QST 713 in Combination with Metrafenone Against Erysiphe necator (UNCINE) on Grapes

The trial was conducted under field conditions. Established grapevine plants (cv. Müller-Thurgau) were grown under standard conditions with adequate supply of water and nutrients. Before disease onset the first application of the products listed in Table 15 below was made. The application was repeated 3 to 6 times (see below) with 14 days intervals applying single products. No other products or compounds were applied for pathogen control. For this purpose, the plants' leaves were sprayed to runoff point with an aqueous formulation having the concentration of active compound stated below. For comparison, a part of the plants was sprayed with metrafenone alone (used as the commercial product Vivando®, BASF; 0.2 l/ha). Another part was sprayed both with metrafenone and B. subtilis strain QST 713 (used as the commercial product Serenade® ASO, from AGRAQUEST; dose rate per treatment: 8 l/ha, diluted with water to 500 l/ha). UNCINE infection occurred naturally. Disease incidences were evaluated 6 days after 5^{th} application (6 DAT(5)) and 15 days after 6^{th} application (15 DAT(6)). Disease levels observed were rated in percent infected clusters in the respective plot given as % attack.

TABLE 15

| | | Attacked clusters [%] | |
|---|---|---|---|
| Treatment | Application code | 6 DAT(5) | 15 DAT(6) |
| Control | — | 44 | 63 |
| Metrafenone | ABC | 7.9 | 26 |
| Metrafenone | ABCDEF | 2.2 | 4.2 |
| Metrafenone | ABC | 2.4 | 8.8 |
| B. subtilis QST 713 | DEF | | |

### Application Code:

| Application code | Application date | Growth stage |
|---|---|---|
| A | 28 May 2008 | 57 |
| B | 11 Jun. 2008 | 65 |
| C | 25 Jun. 2008 | 73 |
| D | 9 Jul. 2008 | 77 |
| E | 23 Jul. 2008 | 79 |
| F | 6 Aug. 2008 | 81 |

16. Activity of B. subtilis Strain QST 713 in Combination with Dithianon Against Botrytis Cinirea (BOTRCI) on Grapes

The trial was conducted under field conditions. Established grapevine plants (cv. Müller-Thurgau) were grown under standard conditions with adequate supply of water and nutrients. Before disease onset the first application of the products listed in Table 16 below was made. The application was repeated 4 to 9 times (see below) with 7-14 days intervals applying single products. No other products or compounds were applied for pathogen control. For this purpose, the plants' leaves were sprayed to runoff point with an aqueous formulation having the concentration of active compound stated below. For comparison, a part of the plants was sprayed with dithianon alone (used as the commercial product Delan®, Bayer CropScience; 0.75 kg/ha). Another part was sprayed both with dithianon and B. subtilis strain QST 713 (used as the commercial product Serenade® ASO, from AGRAQUEST; dose rate per treatment: 8 l/ha, diluted with water to 500 l/ha). BOTRCI infection occurred naturally. Disease incidences were evaluated 21 days after 9^{th} application (21 DAT(9)). Disease levels observed were rated in percent infected clusters in the respective plot given as % attack.

TABLE 16

| | | Attacked clusters [%] |
|---|---|---|
| Treatment | Application code | 21 DAT(9) |
| Dithianon | ABCD | 12 |
| Dithianon | ABCDEFGHI | 15 |
| Dithianon | ABCD | 3.4 |
| B. subtilis QST 713 | EFGHI | |
| Dithianon | ABCDE | 4.2 |
| B. subtilis QST 713 | FGHI | |

### Application Code:

| Application code | Application date | Growth stage |
|---|---|---|
| A | 16 May 2008 | 53 |
| B | 28 May 2008 | 57 |
| C | 4 Jun. 2008 | 63 |
| D | 13 Jun. 2008 | 68 |
| E | 23 Jun. 2008 | 71 |
| F | 4 Jul. 2008 | 75 |
| G | 18 Jul. 2008 | 79 |
| H | 29 Jul. 2008 | 79 |
| I | 7 Aug. 2008 | 81 |

17. Activity of B. subtilis Strain QST 713 in Combination with Dithianon Against Plasmopara viticola (PLASVI) on Grapes

The trial was conducted under field conditions. Established grapevine plants (cv. Müller-Thurgau) were grown under standard conditions with adequate supply of water and nutrients. Before disease onset the first application of the products listed in Table 17 below was made. The application was repeated 4 to 9 times (see below) with 7-14 days intervals applying single products. No other products or compounds were applied for pathogen control. For this purpose, the plants' leaves were sprayed to runoff point with an aqueous formulation having the concentration of active compound stated below. For comparison, a part of the plants was sprayed with dithianon alone (used as the commercial product Delan®, Bayer CropScience; 0.75 kg/ha). Also for comparison, a part of the plants was sprayed with B. subtilis strain QST 713 (used as the commercial product Serenade® ASO, from AGRAQUEST; dose rate per treatment: 8 l/ha, diluted with water to 500 l/ha). Another part was sprayed both with dithianon and B. subtilis strain QST 713. PLASVI infection occurred naturally. Disease incidences were evaluated 10 days after 7^{th} application (10 DAA(7)) and 4 days after 9^{th} application (4 DAA(9)). Disease levels observed were rated in percent infected leaf area (4 DAA(9)) and in percent infected clusters (10 DAA(7)) in the respective plot given as % attack.

TABLE 17

| | | Attacked leaf area/clusters [%] | |
|---|---|---|---|
| Treatment | Application code | 10 DAA***(7) | 4 DAA***(9) |
| Control | — | 80 | 58 |
| Dithianon | ABCD | 30 | 11 |
| Dithianon | ABCDEFGHI | 25 | 7.5 |
| B. subtilis QST 713 | ABCDEFGHI | 70 | 38 |
| Dithianon | ABCD | 25 | 6 |
| B. subtilis QST 713 | EFGHI | | |
| Dithianon | ABCDE | 14 | 4.5 |
| B. subtilis QST 713 | FGHI | | |

***DAA = Days after x^{th} application (x in parantheses)

### Application Code:

| Application code | Application date | Growth stage |
|---|---|---|
| A | 16 May 2008 | 53 |
| B | 28 May 2008 | 57 |
| C | 4 Jun. 2008 | 63 |
| D | 13 Jun. 2008 | 68 |
| E | 23 Jun. 2008 | 71 |
| F | 4 Jul. 2008 | 75 |
| G | 18 Jul. 2008 | 79 |
| H | 29 Jul. 2008 | 79 |
| I | 7 Aug. 2008 | 81 |

18. Activity of B. subtilis Strain QST 713 in Combination with Dithianon Against Venturia inequalis (VENTIN) in Apple

The trial was conducted under field conditions. Established apple plants (cv. Rubinette) were grown under standard conditions with adequate supply of water and nutrients. Before disease onset the first application of the products listed in Table 18 below was made. The application was repeated 6 to 10 times (see below) with 7-14 days intervals applying single products or product mixtures. No other products or compounds were applied for pathogen control. For this purpose, the plants' leaves were sprayed to runoff point with an aqueous formulation having the concentration of active compound stated below. For comparison, a part of the plants was sprayed with dithianon alone (used as the commercial product Delan®, Bayer CropScience; 0.75 kg/ha). Another part was sprayed both with dithianon and B. subtilis strain QST 713 (used as the commercial product Serenade® ASO, from AGRAQUEST; dose rate per treatment: 8 l/ha, diluted with water to 500 l/ha) and with a tank mix containing dithianon (0.43 kg/ha) and B. subtilis strain QST 713. VENTIN infection occurred naturally. Disease incidences were evaluated 6 days after 10^{th} application (6 DAT(10)). Disease levels observed were rated in percent infected leaf area in the respective plot given as % attack.

TABLE 18

| | | Attacked leaf area [%] |
|---|---|---|
| Treatment | Application code | 6 DAT10 |
| Control | — | 58 |
| Dithianon | ABCDEF | 12 |
| Dithianon | ABCDEFGHIJ | 7.3 |
| Dithianon | ABCDEF | 5.9 |
| Tank mix | GH | |
| B. subtilis QST 713 | IJ | |

### Application Code:

| Application code | Application date |
|---|---|
| A | 3 Apr. 2008 |
| B | 11 Apr. 2008 |
| C | 21 Apr. 2008 |
| D | 30 Apr. 2008 |
| E | 14 May 2008 |
| F | 26 May 2008 |
| G | 4 Jun. 2008 |
| H | 14 Jun. 2008 |
| I | 24 Jun. 2008 |
| J | 2 Jul. 2008 |

19. Activity of B. subtilis Strain QST 713 in Combination with Dithianon/a Mixture of Pyrimethanil and Dithianon/a Mixture of Pyraclostrobin and Dithianon Against Venturia inequalis (VENTIN) in Apple

The trial was conducted under field conditions. Established apple plants (cv. Rubinette) were grown under standard conditions with adequate supply of water and nutrients. Before disease onset the first application of the products listed in Table 19 below was made. The application was repeated 10 times (see below) with 7-14 days intervals applying single products or product mixtures. No other products or compounds were applied for pathogen control. For this purpose, the plants' leaves were sprayed to runoff point with an aqueous formulation having the concentration of active compounds stated below. For comparison, a part of the plants was sprayed with dithianon (used as the commercial product Delan®, Bayer CropScience; 0.75 kg/ha), then with a mixture of pyrimethanil and dithianon (used as the commercial product BAS 669 AF F, BASF; 1.2 l/ha), then with a mixture of pyraclostrobin and dithianon (used as the commercial product Maccani®, BASF; 2.5 kg/ha), then again with dithianon, again with maccani and last with dithianon. Another part was sprayed with dithianon (used as the commercial product Delan®, Bayer CropScience; 0.75 kg/ha), then with a mixture of pyrimethanil and dithianon (used as the commercial product BAS 669 AF F, BASF; 1.2 l/ha), then with a mixture of pyraclostrobin and dithianon (used as the commercial product Maccani®, BASF; 2.5 kg/ha), then again with dithianon, and lastly with B. subtilis strain QST 713 (used as the commercial product Serenade® ASO, from AGRAQUEST; dose rate per treatment: 8 l/ha, diluted with water to 500 l/ha) VENTIN infection occurred naturally. Disease incidences were evaluated 6 days after 10^{th} application (6 DAT(10)). Disease levels observed were rated in percent infected leaf area in the respective plot given as % attack.

TABLE 19

| | Application | Attacked leaf area [%] |
|---|---|---|
| Treatment | code | 6 DAT10 |
| Control | — | 58 |
| Dithianon | AB | 3.3 |
| BAS 669 | CD | |
| Maccani | EF | |
| Dithianon | GH | |
| Maccani | I | |
| Dithianon | J | |
| Dithianon | AB | 3.1 |
| BAS 669 | CD | |
| Maccani | EF | |
| Dithianon | G | |
| B. subtilis QST 713 | HIJ | |

### Application Code:

| Application code | Application date |
|---|---|
| A | 3 Apr. 2008 |
| B | 11 Apr. 2008 |
| C | 21 Apr. 2008 |
| D | 30 Apr. 2008 |
| E | 14 May 2008 |
| F | 26 May 2008 |
| G | 4 Jun. 2008 |
| H | 14 Jun. 2008 |
| I | 24 Jun. 2008 |
| J | 2 Jul. 2008 |

20. Activity of B. subtilis Strain QST 713 in Combination with Metrafenone/a Mixture of Boscalid and Kresoxim-Methyl Against Erysiphe necator (UNCINE) in Grape

The trial was conducted under field conditions. Established grapevine plants were grown under standard conditions with adequate supply of water and nutrients. Before disease onset the first application of the products listed in Table 20 below was made. The application was repeated 7 times (see below) with 9-13 days intervals applying single products or product mixtures. No other products or compounds were applied for pathogen control. For this purpose, the plants' leaves were sprayed to runoff point with an aqueous formulation having the concentration of active compounds stated below. For comparison, a part of the plants was sprayed with metrafenone (used as the commercial product Vivando®, BASF; 0.26 l/ha), then with a mixture of boscalid and kresoxim-methyl (used as the commercial product Collis, BASF; 0.4 l/ha), then again with metrafenone and lastly with sulfur (used as the commercial product Kumulus®, BASF, 5 kg/ha). Another part was sprayed with metrafenone (used as the commercial product Vivando®, BASF; 0.26 l/ha), then with a mixture of boscalid and kresoxim-methyl (used as the commercial product Collis®, BASF; 0.4 l/ha), then again with metrafenone and lastly with B. subtilis strain QST 713 (used as the commercial product Serenade® ASO, from AGRAQUEST; dose rate per treatment: 8 l/ha, diluted with water to 500 l/ha) VENTIN infection occurred naturally. Disease incidences were evaluated 7 days after 7^{th} application (7 DAT(7)). Disease levels observed were rated in percent infected clusters in the respective plot given as % attack.

TABLE 20

| | Application | Attacked clusters [%] |
|---|---|---|
| Treatment | code | 6 DAT10 |
| Control | — | 88 |
| Metrafenone | A | 2 |
| Boscalid + Kresoxim-methyl | BCD | |
| Metrafenone | EF | |
| Sulfur | G | |
| Metrafenone | A | 1.5 |
| Boscalid + Kresoxim-methyl | BCD | |
| Metrafenone | E | |
| B. subtilis QST 713 | FG | |

### Application Code:

| Application | Application | Growth |
|---|---|---|
| code | date | stage |
| A | 12 May 2008 | 57 |
| B | 22 May 2008 | 62 |
| C | 2 Jun. 2008 | 69 |
| D | 12 Jun. 2008 | 73 |
| E | 23 Jun. 2008 | 75 |
| F | 3 Jul. 2008 | 79 |
| G | 14 Jul. 2008 | 81 |

21. Activity of B. subtilis Strain QST 713 in Combination with Metrafenone/a Mixture of Pyraclostrobin and Metiram/Boscalid Against Erysiphe necator (UNCINE) in Grape

The trial was conducted under field conditions. Established grapevine plants were grown under standard conditions with adequate supply of water and nutrients. Before disease onset the first application of the products listed in Table 21 below was made. The application was repeated 7 times (see below) with 9-13 days intervals applying single products or product mixtures. No other products or compounds were applied for pathogen control. For this purpose, the plants' leaves were sprayed to runoff point with an aqueous formulation having the concentration of active compounds stated below. For comparison, a part of the plants was sprayed with metrafenone (used as the commercial product Vivando®, BASF; 0.26 l/ha), then with a mixture of pyraclostrobin and metiram (used as the commercial product Cabrio Top, BASF; 1.5 kg/ha), then with boscalid (used as the commercial product Cantus, BASF, 1.2 kg/ha), then again with metrafenone and lastly with sulfur (used as the commercial product Kumulus®, BASF, 5 kg/ha). Another part was sprayed with metrafenone (used as the commercial product Vivando®, BASF; 0.26 l/ha), then with a mixture of pyraclostrobin and metiram (used as the commercial product Cabrio Top, BASF; 1.5 kg/ha), then with boscalid (used as the commercial product Cantus, BASF, 1.2 kg/ha), and lastly with B. subtilis strain QST 713 (used as the commercial product Serenade® ASO, from AGRAQUEST; dose rate per treatment: 8 l/ha, diluted with water to 500 l/ha) VENTIN infection occurred naturally. Disease incidences were evaluated 7 days after 7^{th} application (7 DAT(7)). Disease levels observed were rated in percent infected clusters in the respective plot given as % attack.

TABLE 21

| | Application | Attacked clusters [%] |
|---|---|---|
| Treatment | code | 6 DAT10 |
| Control | — | 88 |
| Metrafenone | A | 9 |
| Pyraclostrobin + Metiram | BCD | |
| Boscalid | E | |
| Metrafenone | F | |
| sulfur | G | |
| Metrafenone | A | 9 |
| Pyraclostrobin + Metiram | BCD | |
| Boscalid | E | |
| B. subtilis QST 713 | FG | |

### Application Code:

| Application | Application | Growth |
|---|---|---|
| code | date | stage |
| A | 12 May 2008 | 57 |
| B | 22 May 2008 | 62 |
| C | 2 Jun. 2008 | 69 |
| D | 12 Jun. 2008 | 73 |
| E | 23 Jun. 2008 | 75 |
| F | 3 Jul. 2008 | 79 |
| G | 14 Jul. 2008 | 81 |

22. Activity of B. subtilis Strain QST 713 in Combination with Boscalid/a Mixture of Fludioxonyl and Cyprodinil Against Sclerotinia sclerotiorum in Beans

Beans were cultivated and grown under standard conditions with adequate supply of water and nutrients. The test plants were inoculated with an aqueous spore suspension of Sclerotinia sclerotiorum. On the dates compiled in table 22 below, the plants' leaves were sprayed to runoff point with an aqueous formulation having the concentration of active compounds stated below. For comparison, a part of the plants was sprayed with a combination of boscalid and a mixture of fludioxinil and cyprodinil alone (boscalid used as the commercial product Cantus®, BASF; dose rate per treatment: 1.0 kg/ha; diluted with water to 500 l/ha; the mixture of fludioxinil and cyprodinil used as the commercial product Switch®, Syngenta; dose rate per treatment: 1.0 kg/ha; diluted with water to 500 l/ha). Another part was sprayed both with boscalid, the mixture of fludioxinil and cyprodinil and B. subtilis strain QST 713 (used as the commercial product Serenade® MAX, from AGRAQUEST; dose rate per treatment: 4 kg/ha, diluted with water to 500 l/ha). 28 and 35 days after the first treatment, the extent of the development of the disease was determined visually in % infection of the plants. The results are compiled in table 22 below.

TABLE 22

| | Application | Attack on plant [%] | |
|---|---|---|---|
| Treatment | code | 28 DAT* | 35 DAT* |
| Control | — | 23 | 43 |
| Fludioxinil + Cyprodinil | A | 2.7 | 9.3 |
| Boscalid | B | | |
| Fludioxinil + Cyprodinil | C | | |
| Fludioxinil + Cyprodinil | A | 1.7 | 4.3 |
| Boscalid | B | | |
| Fludioxinil + Cyprodinil | C | | |
| B. subtilis QST 713 | DE | | |

*DAT = Days after first treatment

### Application Code:

| Application code | Application date | Growth stage |
|---|---|---|
| A | 17 Mar. 2009 | 65 |
| B | 24 Mar. 2009 | 71 |
| C | 31 Mar. 2009 | 71 |
| D | 7 Apr. 2009 | 75 |
| E | 14 Apr. 2009 | 85 |

23. Activity of B. subtilis Strain QST 713 in Combination with Boscalid Against Bremia lactucae in Lettuce

Lettuce was cultivated and grown under standard conditions with adequate supply of water and nutrients. The test plants were inoculated with an aqueous spore suspension of Bremia lactucae. On the dates compiled in table 23 below, the plants' leaves were sprayed to runoff point with an aqueous formulation having the concentration of active compound stated below. For comparison, a part of the plants was sprayed with boscalid alone (used as the commercial product Cantus®, BASF; dose rate per treatment: 1 kg/ha; diluted with water to 500 l/ha). Another part was sprayed both with the boscalid and B. subtilis strain QST 713 (used as the commercial product Serenade® MAX, from AGRAQUEST; dose rate per treatment: 4 kg/ha, diluted with water to 500 l/ha). 7 days after the last treatment, the extent of the development of the disease was determined visually in % infection of the plant. The results are compiled in table 23 below.

TABLE 23

| | Application | Attack on plant [%] |
|---|---|---|
| Treatment | code | 7 DALT** |
| Control | — | 14 |
| Boscalid | AB | 14 |
| Boscalid | AB | 6 |
| B. subtilis QST 713 | CD | |

**DALT = Days after last treatment

### Application Code:

| Application code | Application date | Growth stage |
|---|---|---|
| A | 30 Mar. 2009 | 43 |
| B | 6 Apr. 2009 | 45 |
| C | 13 Apr. 2009 | 47 |
| D | 20 Apr. 2009 | 49 |

24. Activity of B. subtilis Strain QST 713 in Combination with Pyraclostrobin and Boscalid Against Erysiphe spp. in Carrots

Carrots were cultivated and grown under standard conditions with adequate supply of water and nutrients. The test plants were inoculated with an aqueous spore suspension of Erysiphe spp. On the dates compiled in table 24 below, the plants' leaves were sprayed to runoff point with an aqueous formulation having the concentration of active compound stated below. For comparison, a part of the plants was sprayed with a mixture of pyraclostrobin and boscalid alone (used as the commercial product Pristine®, BASF; dose rate per treatment: 200 g/ha; diluted with water to 500 l/ha). Another part was sprayed both with the pyraclostrobin/boscalid mixture and B. subtilis strain QST 713 (used as the commercial product Serenade® MAX, from AGRAQUEST; dose rate per treatment: 4 kg/ha, diluted with water to 500 l/ha). 7 days after the last treatment, the extent of the development of the disease was determined visually in % infection of the plant. The results are compiled in table 24 below.

TABLE 24

| | Application | Attack on plant [%] |
|---|---|---|
| Treatment | code | 7 DALT** |
| Control | — | 68 |
| Pyraclostrobin/Boscalid | A | 33 |
| Pyraclostrobin/Boscalid | A | 23 |
| B. subtilis QST 713 | BCDE | |

**DALT = Days after last treatment

### Application Code:

| Application code | Application date | Growth stage |
|---|---|---|
| A | 2 Apr. 2009 | 41 |
| B | 9 Apr. 2009 | 42 |
| C | 16 Apr. 2009 | 43 |
| D | 23 Apr. 2009 | 44 |
| E | 30 Apr. 2009 | 45 |

25. Activity of B. subtilis Strain QST 713 in Combination with Pyraclostrobin and Boscalid Against Alternaria dauci in Carrots

Carrots were cultivated and grown under standard conditions with adequate supply of water and nutrients. The test plants were inoculated with an aqueous spore suspension of Alternaria dauci. On the dates compiled in table 25 below, the plants' leaves were sprayed to runoff point with an aqueous formulation having the concentration of active compound stated below. For comparison, a part of the plants was sprayed with a mixture of pyraclostrobin and boscalid alone (used as the commercial product Signum®, BASF; dose rate per treatment: 225 g/ha; diluted with water to 500 l/ha). Another part was sprayed both with the pyraclostrobin/boscalid mixture and B. subtilis strain QST 713 (used as the commercial product Serenade® MAX, from AGRAQUEST; dose rate per treatment: 4 kg/ha, diluted with water to 500 l/ha). 35 and 42 days after the first treatment, the extent of the development of the disease was determined visually in % infection of the plant. The results are compiled in table 25 below.

TABLE 25

| | Application | Attack on plant [%] | |
|---|---|---|---|
| Treatment | code | 35 DAT* | 42 DAT* |
| Control | — | 51 | 61 |
| Pyraclostrobin/Boscalid | AB | 8.9 | 10.9 |
| Pyraclostrobin/Boscalid | AB | 6.4 | 6.9 |
| B. subtilis QST 713 | CDE | | |

*DAT = Days after first treatment

### Application Code:

| Application code | Application date | Growth stage |
|---|---|---|
| A | 2 Apr. 2009 | 41 |
| B | 9 Apr. 2009 | 42 |
| C | 16 Apr. 2009 | 43 |
| D | 23 Apr. 2009 | 44 |
| E | 30 Apr. 2009 | 45 |

26. Activity of B. subtilis Strain QST 713 in Combination with Pyraclostrobin, Boscalid and Difenoconazole Against Alternaria dauci in Carrots

Carrots were cultivated and grown under standard conditions with adequate supply of water and nutrients. The test plants were inoculated with an aqueous spore suspension of Alternaria dauci. On the dates compiled in table 26 below, the plants' leaves were sprayed to runoff point with an aqueous formulation having the concentration of active compound stated below. For comparison, a part of the plants was sprayed with a mixture of pyraclostrobin and boscalid (used as the commercial product Signum®, BASF; dose rate per treatment: 225 g/ha; diluted with water to 500 l/ha) followed by difenoconazole (used as the commercial product Bardos®, dose rate per treatment: 400 g/ha; diluted with water to 500 l/ha). Another part was sprayed both with the pyraclostrobin/boscalid mixture, difenoconazole and B. subtilis strain QST 713 (used as the commercial product Serenade® MAX, from AGRAQUEST; dose rate per treatment: 4 kg/ha, diluted with water to 500 l/ha). 35 and 42 days after the first treatment, the extent of the development of the disease was determined visually in % infection of the plant. The results are compiled in table 26 below.

TABLE 26

| | Application | Attack on plant [%] | |
|---|---|---|---|
| Treatment | code | 35 DAT* | 42 DAT* |
| Control | — | 51 | 61 |
| Pyraclostrobin/Boscalid | A | 9.8 | 15.2 |
| Difenoconazole | B | | |
| Pyraclostrobin/Boscalid | A | 6.8 | 9.2 |
| Difenoconazole | B | | |
| B. subtilis QST 713 | CDE | | |

*DAT = Days after first treatment

### Application Code:

| Application code | Application date | Growth stage |
|---|---|---|
| A | 2 Apr. 2009 | 41 |
| B | 9 Apr. 2009 | 42 |
| C | 16 Apr. 2009 | 43 |
| D | 23 Apr. 2009 | 44 |
| E | 30 Apr. 2009 | 45 |

27. Activity of B. subtilis Strain QST 713 in Combination with Metrafenone Against Sphaerotheca fuliginea in Cucumber

Cucumbers were cultivated and grown under standard conditions with adequate supply of water and nutrients. The test plants were inoculated with an aqueous spore suspension of Sphaerotheca fuliginea. On the dates compiled in table 27 below, the plants' leaves were sprayed to runoff point with an aqueous formulation having the concentration of active compound stated below. For comparison, a part of the plants was sprayed metrafenone alone (used as the commercial product Vivando, BASF; dose rate per treatment: 0.3 l/ha; diluted with water to 500 l/ha). Another part was sprayed both with metrafenone and B. subtilis strain QST 713 (used as the commercial product Serenade® MAX, from AGRAQUEST; dose rate per treatment: 4 kg/ha, diluted with water to 500 l/ha). 38 days after the first treatment, the extent of the development of the disease was determined visually in % infection of the leaves. The results are compiled in table 27 below.

TABLE 27

| Treatment | Application code | Attack on leaves [%] |
|---|---|---|
| Control | — | 69 |
| Metrafenone | ABC | 15 |
| Metrafenone | ABC | 7.6 |
| B. subtilis QST 713 | DE | |

*DAT = Days after first treatment

### Application Code:

| Application code | Application date | Growth stage |
|---|---|---|
| A | 1 Apr. 2009 | 13 |
| B | 8 Apr. 2009 | 15 |
| C | 15 Apr. 2009 | 18 |
| D | 23 Apr. 2009 | 73 |
| E | 30 Apr. 2009 | 75 |

28. Activity of B. subtilis Strain QST 713 in Combination with Metrafenone, Boscalid and Kresoxim-Methyl Against Erysiphe necator in Grapes

Grapes were grown under standard conditions with adequate supply of water and nutrients. The test plants were inoculated with an aqueous spore suspension of Erysiphe necator. On the dates compiled in table 28 below, the plants' leaves were sprayed to runoff point with an aqueous formulation having the concentration of active compound stated below. For comparison, a part of the plants was sprayed with metrafenone (used as the commercial product Vivando, BASF; dose rate per treatment: 0.27 l/ha; diluted with water to 800 l/ha) and a mixture of kresoxim-methyl and boscalid (used as the commercial product Collis®, BASF; dose rate per treatment: 0.4 l/ha; diluted with water to 800 l/ha). Another part was sprayed both with metrafenone, the kresoxim-methyl/boscalid mixture and B. subtilis strain QST 713 (used as the commercial product Serenade® MAX, from AGRAQUEST; dose rate per treatment: 4 kg/ha, diluted with water to 800 l/ha). 12 days after the 8^{th} and 5 days after the 9^{th} application, the extent of the development of the disease was determined visually in % infection of the clusters. The results are compiled in table 28 below.

TABLE 28

| | Application | Attack on clusters [%] | |
|---|---|---|---|
| Treatment | code | 12 DAA*** (8) | 5 DAA*** (9) |
| Control | — | 31 | 55 |
| Metrafenone | AC | 10 | 37 |
| Kresoxim-methyl/Boscalid | BD | | |
| Metrafenone | AC | 3.4 | 16 |
| Kresoxim-methyl/Boscalid | BD | | |
| B. subtilis QST 713 | EFGHI | | |

***DAA = Days after x^{th} application (x in parantheses)

### Application Code:

| Application code | Application date | Growth stage |
|---|---|---|
| A | 24 Apr. 2009 | 15 |
| B | 6 May 2009 | 53 |
| C | 15 May 2009 | 55 |
| D | 25 May 2009 | 59 |
| E | 4 Jun. 2009 | 65 |
| F | 16 Jun. 2009 | 71 |
| G | 26 Jun. 2009 | 73 |
| H | 8 Jul. 2009 | 77 |
| I | 20 Jul. 2009 | 79 |

29. Activity of B. subtilis Strain QST 713 in Combination with Metrafenone Against Erysiphe necator in Grapes

Grapes were grown under standard conditions with adequate supply of water and nutrients. The test plants were inoculated with an aqueous spore suspension of Erysiphe necator. On the dates compiled in table 29 below, the plants' leaves were sprayed to runoff point with an aqueous formulation having the concentration of active compound stated below. For comparison, a part of the plants was sprayed with metrafenone alone (used as the commercial product Vivando, BASF; dose rate per treatment: 0.27 l/ha; diluted with water to 800 l/ha). Another part was sprayed both with metrafenone and B. subtilis strain QST 713 (used as the commercial product Serenade® MAX, from AGRAQUEST; dose rate per treatment: 4 kg/ha, diluted with water to 800 l/ha). 11 days after the 6^{th} application, the extent of the development of the disease was determined visually in % infection of the clusters. The results are compiled in table 29 below.

TABLE 29

| | Application | Attack on clusters [%] |
|---|---|---|
| Treatment | code | 11 DAA*** (6) |
| Control | — | 61 |
| Metrafenone | ABCD | 25 |
| Metrafenone | ABCD | 12 |
| B. subtilis QST 713 | EF | |

***DAA (6) = Days after 6^{th} application

### Application Code:

| Application code | Application date | Growth stage |
|---|---|---|
| A | 6 May 2009 | 53 |
| B | 20 May 2009 | 57 |
| C | 3 Jun. 2009 | 61 |
| D | 18 Jun. 2009 | 71 |
| E | 2 Jul. 2009 | 75 |
| F | 16 Jul. 2009 | 79 |

1.-15. (canceled)

16. A method for controlling harmful fungi, which method comprises subjecting plants to be protected against fungal attack to two or more sequential treatment blocks,
where at least one treatment block comprises treating the plants with at least one synthetic fungicide and at least one treatment block comprises treating the plants with at least one biological control agent,
with the proviso that the last treatment block comprises treating the plants with at least one biological control agent selected from Bacillus subtilis and metabolites produced therefrom.

17. The method of claim 16, where the two or more sequential treatment blocks are carried out during different growth stages of the plants.

18. The method of claim 16, which comprises subjecting plants to be protected against fungal attack to first and second sequential treatment blocks, where the first treatment block comprises treating the plants with at least one synthetic fungicide and the second, subsequent treatment block comprises treating the plants with at least one biological control agent.

19. The method of claim 18, where the first and the second treatment blocks are carried out during different growth stages of the plants.

20. The method of claim 16, where the first treatment block ends latest when the plants have reached growth stage 81 according to the BBCH extended scale, and the last treatment block begins earliest when the plants are in growth stage 41 according to BBCH extended scale.

21. The method of claim 20, where the first treatment block ends latest when the plants have reached growth stage 79 according to BBCH extended scale and the last treatment block begins earliest when the plants are in growth stage 41 according to BBCH extended scale.

22. The method of claim 21, where the first treatment block is carried out when the plants are in the growth stage 10 to 79 according to BBCH extended scale and the last treatment block is carried out when the plants are in the growth stage 41 to 92 according to BBCH extended scale.

23. The method of claim 16, where Bacillus subtilis strain QST 713 is used.

24. The method of claim 36, where the synthetic fungicide is selected from the group consisting of
A) azoles, selected from the group consisting of
azaconazole, bitertanol, bromuconazole, cyproconazole, difenoconazole, diniconazole, diniconazole-M, epoxiconazole, fenbuconazole, fluquinconazole, flusilazole, flutriafol, hexaconazole, imibenconazole, ipconazole, metconazole, myclobutanil, oxpoconazole, paclobutrazole, penconazole, propiconazole, prothioconazole, simeconazole, tebuconazole, tetraconazole, triadimefon, triadimenol, triticonazole, uniconazole, 1-(4-chloro-phenyl)-2-([1,2,4]triazol-1-yl)-cycloheptanol, cyazofamid, imazalil, pefurazoate, prochloraz, triflumizol, benomyl, carbendazim, fuberidazole, thiabendazole, ethaboxam, etridiazole, hymexazole and 2-(4-chloro-phenyl)-N-[4-(3,4-dimethoxy-phenyl)-isoxazol-5-yl]-2-prop-2-ynyloxy-acetamide;
B) strobilurins, selected from the group consisting of
azoxystrobin, dimoxystrobin, enestroburin, fluoxastrobin, kresoxim-methyl, metominostrobin, orysastrobin, picoxystrobin, pyraclostrobin, pyribencarb, trifloxystrobin, 2-(2-(6-(3-chloro-2-methyl-phenoxy)-5-fluoro-pyrimidin-4-yloxy)-phenyl)-2-methoxyimino-N-methyl-acetamide, 3-methoxy-2-(2-(N-(4-methoxy-phenyl)-cyclopropane-carboximidoylsulfanylmethyl)-phenyl)-acrylic acid methyl ester, methyl (2-chloro-5-[1-(3-methylbenzyloxyimino)ethyl]benzyl)carbamate and 2-(2-(3-(2,6-dichlorophenyl)-1-methyl-allylideneaminooxymethyl)-phenyl)-2-methoxyimino-N-methyl-acetamide;
C) carboxamides, selected from the group consisting of
benalaxyl, benalaxyl-M, benodanil, bixafen, boscalid, carboxin, fenfuram, fenhexamid, flutolanil, furametpyr, isopyrazam, isotianil, kiralaxyl, mepronil, metalaxyl, metalaxyl-M (mefenoxam), ofurace, oxadixyl, oxycarboxin, penthiopyrad, sedaxane, tecloftalam, thifluzamide, tiadinil, 2-amino-4-methylthiazole-5-carboxanilide, 2-chloro-N-(1,1,3-trimethyl-indan-4-yl)-nicotinamide, N-(3′,4′,5′-trifluorobiphenyl-2-yl)-3-difluoromethyl-1-methyl-1H-pyrazole-4-carboxamide, N-(4′-trifluoromethylthiobiphenyl-2-yl)-3-difluoromethyl-1-methyl-1H-pyrazole-4-carboxamide, N-(2-(1,3-dimethyl-butyl)-phenyl)-1,3-dimethyl-5-fluoro-1H-pyrazole-4-carboxamide and N-(2-(1,3,3-trimethyl-butyl)phenyl)-1,3-dimethyl-5-fluoro-1H-pyrazole-4-carboxamide, dimethomorph, flumorph, pyrimorph, flumetover, fluopicolide, fluopyram, zoxamide, N-(3-Ethyl-3,5,5-trimethyl-cyclohexyl)-3-formylamino-2-hydroxy-benzamide, carpropamid, dicyclomet, mandiproamid, oxytetracyclin, silthiofarm and N-(6-methoxy-pyridin-3-yl)cyclopropanecarboxylic acid amide;
D) heterocyclic compounds, selected from the group consisting of
fluazinam, pyrifenox, 3-[5-(4-chloro-phenyl)-2,3-dimethyl-isoxazolidin-3-yl]-pyridine, 3-[5-(4-methyl-phenyl)-2,3-dimethyl-isoxazolidin-3-yl]-pyridine, 2,3,5,6-tetra-chloro-4-methanesulfonyl-pyridine, 3,4,5-trichloropyridine-2,6-di-carbonitrile, N-(1-(5-bromo-3-chloro-pyridin-2-yl)-ethyl)-2,4-dichloro-nicotinamide, N-[(5-bromo-3-chloro-pyridin-2-yl)-methyl]-2,4-dichloro-nicotinamide, bupirimate, cyprodinil, diflumetorim, fenarimol, ferimzone, mepanipyrim, nitrapyrin, nuarimol, pyrimethanil, triforine, fenpiclonil, fludioxonil, aldimorph, dodemorph, dodemorph-acetate, fenpropimorph, tridemorph, fenpropidin, fluoroimid, iprodione, procymidone, vinclozolin, famoxadone, fenamidone, flutianil, octhilinone, probenazole, 5-amino-2-isopropyl-3-oxo-4-ortho-tolyl-2,3-dihydro-pyrazole-1-carbothioic acid S-allyl ester, acibenzolar-5-methyl, amisulbrom, anilazin, blasticidin-S, captafol, captan, chinomethionat, dazomet, debacarb, diclomezine, difenzoquat, difenzoquat-methylsulfate, fenoxanil, Folpet, oxolinic acid, piperalin, proquinazid, pyroquilon, quinoxyfen, triazoxide, tricyclazole, 2-butoxy-6-iodo-3-propylchromen-4-one, 5-chloro-1-(4,6-dimethoxy-pyrimidin-2-yl)-2-methyl-1H-benzoimidazole, 5-chloro-7-(4-methylpiperidin-1-yl)-6-(2,4,6-trifluorophenyl)-[1,2,4]triazolo[1,5-a]pyrimidine, and 5-ethyl-6-octyl-[1,2,4]triazolo[1,5-a]pyrimidine-7-ylamine;
E) carbamates, selected from the group consisting of
ferbam, mancozeb, maneb, metam, methasulphocarb, metiram, propineb, thiram, zineb, ziram, benthiavalicarb, diethofencarb, iprovalicarb, propamocarb, propamocarb hydrochlorid, valiphenal and N-(1-(1-(4-cyano-phenyl)ethanesulfonyl)-but-2-yl) carbamic acid-(4-fluorophenyl) ester;
and
F) other active compounds, selected from the group consisting of
guanidines: guanidine, dodine, dodine free base, guazatine, guazatine-acetate, iminoctadine, iminoctadine-triacetate, iminoctadine-tris(albesilate);
nitrophenyl derivates: binapacryl, dinobuton, dinocap, nitrthal-isopropyl, tecnazen,
organometal compounds: fentin salts, such as fentin-acetate, fentin chloride or fentin hydroxide;
sulfur-containing heterocyclyl compounds: dithianon, isoprothiolane;
organophosphorus compounds: edifenphos, fosetyl, fosetyl-aluminum, iprobenfos, phosphorous acid and its salts, pyrazophos, tolclofos-methyl;
organochlorine compounds: chlorothalonil, dichlofluanid, dichlorophen, flusulfamide, hexachlorobenzene, pencycuron, pentachlorphenole and its salts, phthalide, quintozene, thiophanate-methyl, tolylfluanid, N-(4-chloro-2-nitrophenyl)-N-ethyl-4-methyl-benzenesulfonamide;
inorganic active substances: Bordeaux mixture, copper acetate, copper hydroxide, copper oxychloride, basic copper sulfate, sulfur;
others: biphenyl, bronopol, cyflufenamid, cymoxanil, diphenylamin, metrafenone, mildiomycin, oxin-copper, prohexadione-calcium, spiroxamine, tolylfluanid, N-(cyclopropylmethoxyimino-(6-difluoro-methoxy-2,3-difluoro-phenyl)-methyl)-2-phenyl acetamide, N′-(4-(4-chloro-3-trifluoromethyl-phenoxy)-2,5-dimethylphenyl)-N-ethyl-N-methyl formamidine, N′-(4-(4-fluoro-3-trifluoromethylphenoxy)-2,5-dimethyl-phenyl)-N-ethyl-N-methyl formamidine, N′-(2-methyl-5-trifluoromethyl-4-(3-trimethylsilanyl-propoxy)-phenyl)-N-ethyl-N-methyl formamidine, N′-(5-difluoromethyl-2-methyl-4-(3-trimethylsilanyl-propoxy)phenyl)-N-ethyl-N-methyl formamidine, 2-{1-[2-(5-methyl-3-trifluoromethyl-pyrazole-1-yl)-acetyl]-piperidin-4-yl}-thiazole-4-carboxylic acid methyl-(1,2,3,4-tetrahydro-naphthalen-1-yl)-amide, 2-{1-[2-(5-methyl-3-trifluoromethyl-pyrazole-1-yl)-acetyl]-piperidin-4-yl}-thiazole-4-carboxylic acid methyl-(R)-1,2,3,4-tetrahydro-naphthalen-1-yl-amide, acetic acid 6-tert.-butyl-8-fluoro-2,3-dimethyl-quinolin-4-yl ester and methoxy-acetic acid 6-tert-butyl-8-fluoro-2,3-dimethyl-quinolin-4-yl ester
and mixtures thereof.

25. The method of claim 24, where the synthetic fungicide is selected from the group consisting of boscalid, metrafenone, dithianon, 7-amino-6-octyl-5-ethyltriazolopyrimidine, pyraclostrobin, kresoxim-methyl, pyrimethanil, meiram, difenoconazole, cyprodinil, fludioxonil and mixtures thereof.

26. The method of claim 16, where
the biological control agent is Bacillus subtilis strain QST 713 and the synthetic fungicide is boscalid; or
the biological control agent is Bacillus subtilis strain QST 713 and the synthetic fungicide is metrafenone; or
the biological control agent is Bacillus subtilis strain QST 713 and the synthetic fungicide is dithianon; or
the biological control agent is Bacillus subtilis strain QST 713 and the synthetic fungicide is 5-ethyl-6-octyl-[1,2,4]triazolo[1,5-a]pyrimidine-7-ylamine; or
the biological control agent is Bacillus subtilis strain QST 713 and the synthetic fungicide is pyraclostrobin; or
the biological control agent is Bacillus subtilis strain QST 713 and the synthetic fungicide is fludioxonil; or
the biological control agent is Bacillus subtilis strain QST 713 and the synthetic fungicide is cyprodinil; or
the biological control agent is Bacillus subtilis strain QST 713 and the synthetic fungicide is difenoconazole; or
the biological control agent is Bacillus subtilis strain QST 713 and the synthetic fungicide is a mixture of pyraclostrobin and boscalid; or
the biological control agent is Bacillus subtilis strain QST 713 and the synthetic fungicide is metiram; or
the biological control agent is Bacillus subtilis strain QST 713 and the synthetic fungicide is pyrimethanil; or
the biological control agent is Bacillus subtilis strain QST 713 and the synthetic fungicide is kresoxim-methyl; or
the biological control agent is Bacillus subtilis strain QST 713 and the synthetic fungicide is a mixture of pyrimethanil and dithianon; or
the biological control agent is Bacillus subtilis strain QST 713 and the synthetic fungicide is a mixture of pyraclostrobin and dithianon; or
the biological control agent is Bacillus subtilis strain QST 713 and the synthetic fungicide is a mixture of boscalid and kresoxim-methyl; or
the biological control agent is Bacillus subtilis strain QST 713 and the synthetic fungicide is a mixture of pyraclostrobin and metiram; or
the biological control agent is Bacillus subtilis strain QST 713 and the synthetic fungicide is a combination of dithianon, a mixture of dithianon and pyrimethanil and a mixture of dithianon and pyraclostrobin; or
the biological control agent is Bacillus subtilis strain QST 713 and the synthetic fungicide is a combination of metrafenone and a mixture of boscalid and kresoxim-methyl; or
the biological control agent is Bacillus subtilis strain QST 713 and the synthetic fungicide is a combination of metrafenone, a mixture of pyraclostrobin and metiram and boscalid; or
the biological control agent is Bacillus subtilis strain QST 713 and the synthetic fungicide is a combination of boscalid and a mixture of fludioxonil and cyprodinil; or
the biological control agent is Bacillus subtilis strain QST 71.3 and the synthetic fungicide is a combination of difenoconazole and a mixture of boscalid and pyraclostrobin.

27. The method of claim 16, where the plants are selected from the group consisting of grape, pome fruit, stone fruit, citrus fruit, banana, strawberry, blueberry, almond, mango, papaya, cucurbit, pumpkin/squash, cucumber, melon, watermelon, kale, cabbage, Chinese cabbage, lettuce, endive, asparagus, carrot, celeriac, kohlrabi, chicory, radish, swede, scorzonerea, Brussels sprout, cauliflower, broccoli, onion, leek, garlic, shallot, tomato, potato, paprika, sugar beet, fodder beet, lentil, vegetable pea, fodder pea, bean, alfalfa (lucerne), soybeans, oilseed rape, mustard, sunflower, groundnut (peanut), maize (corn), wheat, triticale, rye, barley, oats, millet/sorghum, rice, cotton, flax, hemp, jute, spinach, sugar cane, tobacco and ornamental plants.

28. The method of claim 27, where the plants are selected from the group consisting of grape, pome fruit, stone fruit, cucurbit, melon, cabbage, tomato, paprika, sugar beet, bean, cucumber, lettuce and carrot.
